(19) United States
(12) Patent Application Publication
(10) Pub. No.: US 2023/0422345 A1
(43) Pub. Date: Dec. 28, 2023

(54) METHODS, COMMUNICATIONS DEVICES AND INFRASTRUCTURE EQUIPMENT

(71) Applicant: Sony Group Corporation, Tokyo (JP)

(72) Inventors: Shin Horng WONG, Basingstoke (GB); Martin Warwick BEALE, Basingstoke (GB); Yassin Aden AWAD, Basingstoke (GB); Naoki KUSASHIMA, Tokyo (JP)

(73) Assignee: Sony Group Corporation, Tokyo (JP)

(21) Appl. No.: 18/029,392

(22) PCT Filed: Sep. 24, 2021
(86) PCT No.: PCT/EP2021/076415

§ 371 Date: Mar. 30, 2023

(30) Foreign Application Priority Data
Oct. 22, 2020 (EP) 20203465.8

(51) Int. Cl. H04W 76/36; H04W 74/08; H04W 16/14

(52) U.S. Cl. CPC H04W 76/36; H04W 16/14; H04W 74/0808

(57) ABSTRACT

A method of operating a communications device comprises determining that the communications device can transmit data via communications resources of an unlicensed channel of a wireless access interface, which is shared in time with at least one of an infrastructure equipment of a wireless communications network and one or more other communications devices which can also transmit in the unlicensed channel. The transmission of the data by the communications device is arranged in time according to a fixed frame period (FFP) including a channel occupancy time (COT) for transmitting the data and an idle period. The communications device can transmit the data on the unlicensed channel by detecting that none of the infrastructure equipment and the one or more other communications devices are transmitting on the unlicensed channel as part of a contentious channel access phase.

### BACKGROUND

### Field of Disclosure

The present disclosure relates to communications devices, infrastructure equipment and methods of operating by a communications device in a wireless communications network.

The present disclosure claims the Paris convention priority to European patent application number EP20203465.2 the contents of which are incorporated herein by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to routinely and efficiently support communications with an ever increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running.

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is Enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

The increasing use of different types of network infrastructure equipment and communications devices can give rise to new challenges, for example those associated with transmitting low latency data in an unlicensed frequency band.

### SUMMARY OF THE DISCLOSURE

The present disclosure can help address or mitigate at least some of the issues discussed above.

According to one aspect, disclosed embodiments of the present technique can provide a method of operating a communications device comprising determining that the communications device can transmit data via communications resources of an unlicensed channel of a wireless access interface, which is shared in time with one or more other communications devices or an infrastructure equipment of a wireless communications network. The unlicensed channel may for example provide frequency domain communications resources within a bandwidth of the unlicensed channel, which are shared in time with the infrastructure equipment and the one or more other communications devices, which can also transmit in the unlicensed channel. The determining that the communications device can transmit the data on the unlicensed channel comprises detecting that none of the infrastructure equipment or the one or more other communications devices are transmitting on the unlicensed channel as part of a clear channel assessment (CCA) phase associated with a channel occupancy time (COT) of a fixed frame period (FFP) of the communications device, the FFP comprising the COT and an idle period. The method includes determining that one or more portions of the COT of the FFP are unused by the communications device before or after a time of transmitting at least part of the data in the COT. This is because the data is or can be transmitted in the COT in a time period, which is less than a temporal length of the COT. The method includes releasing the one or more unused portions of the unlicensed channel providing communications resources of the COT for use by at least one of the infrastructure equipment and the one or more other communications devices to transmit signals.

Example embodiments can provide an arrangement in which communications resources of an unlicensed channel which are shared in time and acquired after a CCA phase associated with an FFP providing a COT of these communications resources and which are unused can be released by a communications device or an infrastructure equipment for use by another communications device or infrastructure equipment. In some example embodiments an arrangement is provided in which a device, which has initiated a CCA phase and acquired ownership of a channel occupancy time (COT) can release part of its COT before the end of its reserved FFP. The device can be a communications device or an infrastructure equipment, that is to say the technique is applicable for any device transmitting uplink or downlink signals.

According to another aspect, disclosed embodiments of the present technique can provide a method of operating an infrastructure equipment comprising determining that the infrastructure equipment can transmit data via communications resources of an unlicensed channel of a wireless access interface shared in time. The determining that the infrastructure equipment can transmit the data on the communications resources of the unlicensed channel comprises detecting that another communications device, which has transmitted signals in a COT of an FFP of the other communications device, has released one or more portions of the COT of the FFP providing one or more communications resources of the unlicensed channel which are unused by the communications device. The communications resources of the COT are unused by the other communications device because signals are transmitted in some part of the COT for a period which does not extend for a total temporal length of the COT. The one or more released portions of the COT provide communications resources of the unlicensed channel which are released by the other communications device as a release device, the infrastructure equipment being a recipient device. The method may include transmitting, by the infrastructure equipment as the recipient device, the data in one or more of the released portions of the unlicensed channel, providing the communications resources of the COT of the FFP of the release device. In another example another of the communications devices may be a recipient device and/or the infrastructure equipment is the release device.

Embodiments of the present technique, which, in addition to methods of operating communications devices, relate to methods of operating infrastructure equipment, communications devices and infrastructure equipment, and circuitry for communications devices and infrastructure equipment, allow for more efficient use of radio resources by a communications device.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system, which may be configured to operate in accordance with certain embodiments of the present disclosure;

FIG. 3 is a schematic block diagram of an example infrastructure equipment and communications device, which may be configured to operate in accordance with certain embodiments of the present disclosure;

FIG. 4 illustrates an example of a New Radio Unlicensed (NR-U) Channel Access on a grid of radio communications resources;

FIG. 5 illustrates an example of Type 1 and Type 2 Dynamic Channel Access on an uplink and downlink grid of radio communications resources;

FIG. 6 illustrates examples of Type 2 Dynamic Channel Access on a grid of radio communications resources;

FIG. 7 illustrates graphically time and frequency resources allocated for a fixed frame period of a wireless access interface for an unlicensed band (NR-U) and include a channel occupancy time (COT), an idle period and clear channel assessment (CCA) processes on the idle period;

FIG. 8 illustrates graphically time and frequency resources of a fixed frame period (FFP) of a communications device (UE) and an infrastructure equipment (gNB) which are offset in time;

FIG. 9 illustrates graphically time and frequency resources of a fixed frame period of a communications device (UE) and an infrastructure equipment (gNB) in which transmission by the gNB is delayed as a result of the UE occupying shared communications resources of its COT;

FIG. 10 illustrates graphically time and frequency resources of a fixed frame period of a first and a second communications device (UE1, UE2) and an infrastructure equipment (gNB) providing an example of a general release of shared communications resources according to an example embodiment;

FIG. 11 illustrates graphically time and frequency resources of a fixed frame period of a communications device (UE) and an infrastructure equipment (gNB) in which remaining shared communications resources of a COT are transferred to a recipient device according to an example embodiment;

FIG. 12 illustrates graphically time and frequency resources of a fixed frame period of a communications device (UE) and an infrastructure equipment (gNB) in which remaining shared communications resources of a COT of the UE are transferred to the gNB as a recipient device which adopts its own fixed frame period according to an example embodiment;

FIG. 13 illustrates graphically time and frequency resources of a fixed frame period of a communications device (UE) and an infrastructure equipment (gNB) in which remaining shared communications resources of a COT of the UE are transferred to the gNB as a recipient device which adopts the fixed frame period of the release device according to an example embodiment;

FIG. 14 illustrates graphically time and frequency resources of a fixed frame period of a communications device (UE) and an infrastructure equipment (gNB) in which remaining shared communications resources of a COT of the UE are merged with the COT of a fixed frame period of the gNB as a recipient device according to an example embodiment;

FIG. 15 illustrates graphically time and frequency resources of a fixed frame period of a communications device (UE) and an infrastructure equipment (gNB) in which remaining shared communications resources of a COT of the UE are merged with the COT of a next fixed frame period of the gNB as a recipient device according to an example embodiment;

FIG. 16 illustrates graphically time and frequency resources of a fixed frame period of a communications device (UE) and an infrastructure equipment (gNB) in which remaining shared communications resources of a COT of the UE are partially released for use by the gNB as a recipient device according to an example embodiment;

FIG. 17 illustrates graphically time and frequency resources of a fixed frame period of a communications device (UE) and an infrastructure equipment (gNB) in which remaining shared communications resources of a COT of the UE are released on command by the gNB as a recipient device according to an example embodiment; and

FIG. 18 illustrates graphically time and frequency resources of a fixed frame period of a communications device (UE) and an infrastructure equipment (gNB) in which remaining shared communications resources of a COT of the UE that are released by the UE are indicated by uplink control information transmitted to the gNB as a recipient device according to an example embodiment.

### DETAILED DESCRIPTION OF THE EMBODIMENTS

Long Term Evolution Advanced Radio Access Technology (4G)

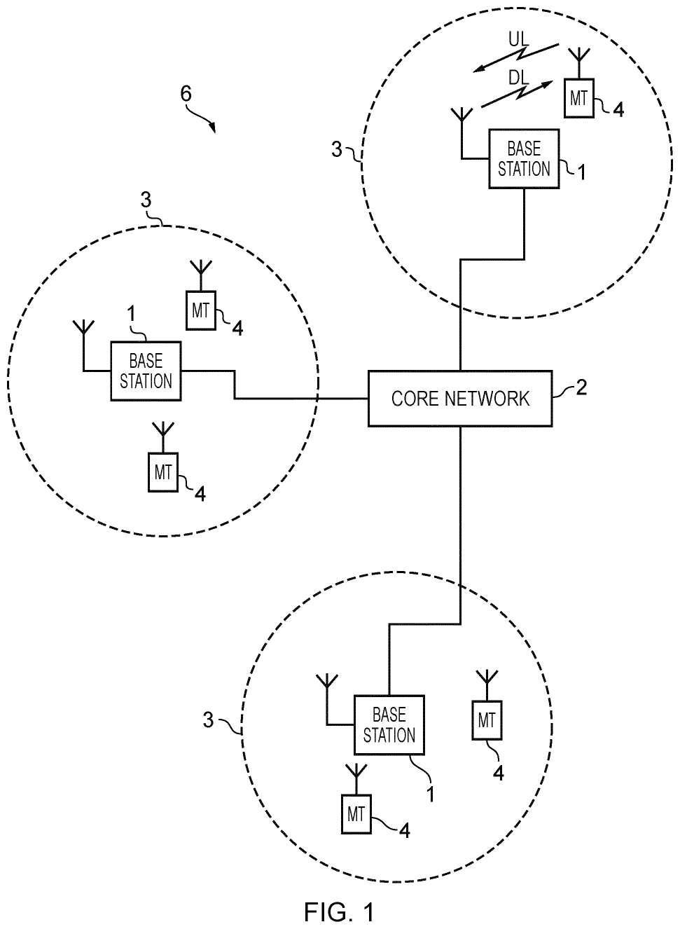

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [7]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

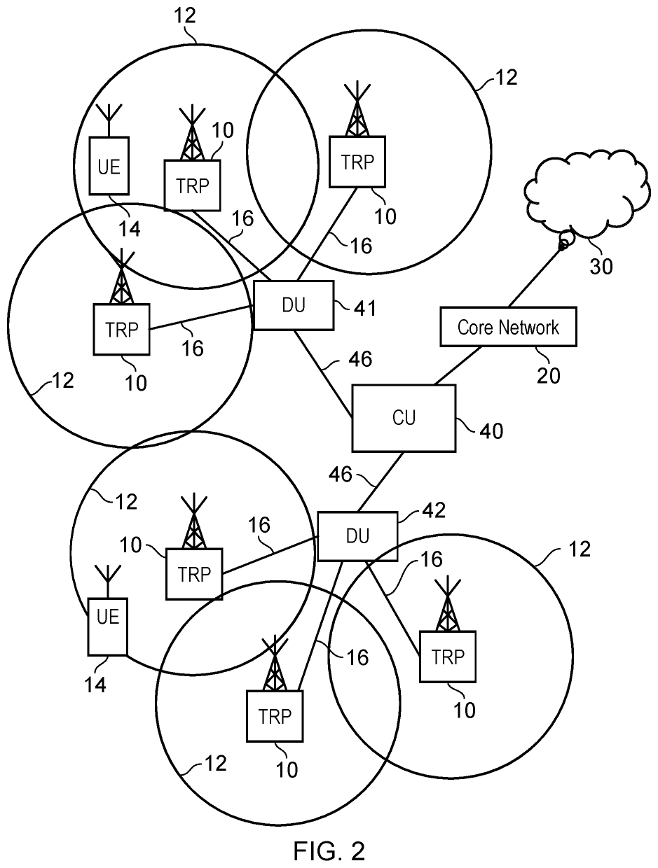

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

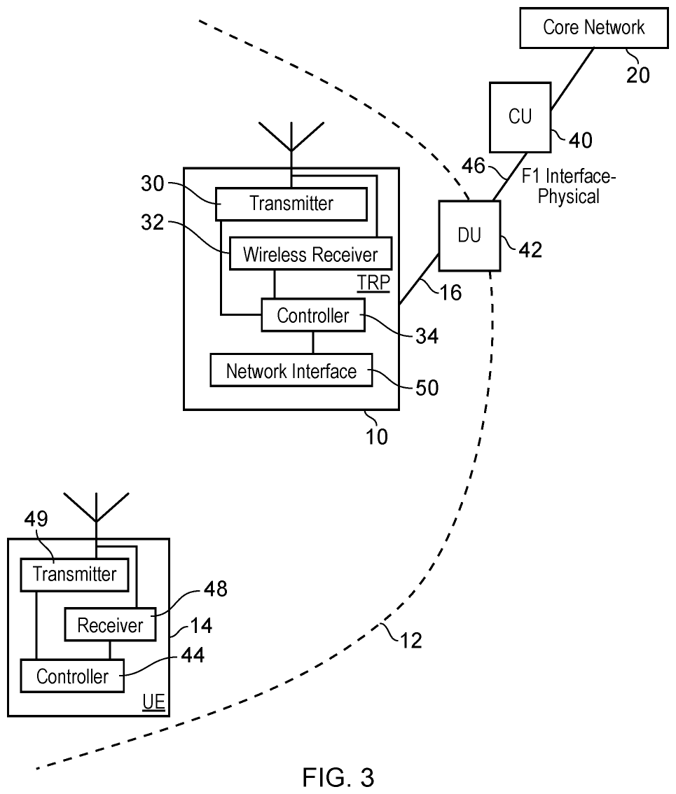

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection (for example a microwave link). In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

eURLLC and NR-U

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. A requirement for Ultra Reliable and Low Latency Communications (URLLC) services is that one transmission of a 32 byte packet is required to be transmitted from the radio protocol layer 2/3 SDU ingress point to the radio protocol layer 2/3 SDU egress point of the radio interface within 1 ms with a reliability of 1-10-5 (99.999%) or higher (99.9999%) [2]. Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Another such service incorporating NR technology is 5G NR in Unlicensed Spectrum (NR-U) [3], which enable devices to make use of shared and unlicensed spectrum bandwidth. Such features as Listen Before Talk (LBT), as specified by [3], may be incorporated into the NR frame structure for NR-U operation in unlicensed bands.

Channel Access in an Unlicensed Band

In the following paragraphs, an explanation is provided of current proposals for accessing communications from an unlicensed frequency band. In an unlicensed band, two or more systems may operate to communicate using the same communications resources. As a result, transmissions from different systems can interfere with each other especially when for example, each of the different systems are configured according to different technical standards, for example Wi-Fi and 5G. As such, there is a regulatory requirement to use an LBT protocol for each transmitter operating in an unlicensed band to reduce interferences among different systems sharing that band. In LBT, a device that wishes to transmit a packet will firstly sense the band for any energy levels above a threshold to determine if any other device is transmitting, i.e. it listens, and if there is no detected transmission, the device will then transmit its packet. Otherwise, if the device senses a transmission from another device it will back-off and try again at a later time.

In NR-U the channel access can be Dynamic (also known as Load Based Equipment) or Semi-Static (also known as Frame Based Equipment). The dynamic channel access schemes consist of one or more Clear Channel Assessment (CCA) phases in a Contention Window followed by a Channel Occupancy Time (COT) phase as shown FIG. 4. LBT is performed during the CCA phase by an NR-U device (e.g. gNB or UE) that wishes to perform a transmission. According to the CCA phase, the NR-U device listens to one or more CCA slots and if no other transmission is detected (i.e. energy level is determined to below a threshold for the duration of the one or more CCA slots) after the CCA phase, the NR-U device moves into the COT phase where it can transmit its packet in the COT resources. In Dynamic Channel Access (DCA) the length of the CCA and COT phases can differ between different systems whilst in Semi-static Channel Access, the CCA and COT phases have fixed time windows and are synchronised for all systems sharing the band. Further details on channel access in NR-U may be found in co-pending European patent application with application number EP20187799.0 [6].

In NR-U a device can be an initiating device or a responding device. The initiating device acquires the COT by performing CCA and typically it initiates a first transmission, e.g. a gNB transmitting an uplink grant. The responding device receives the transmission from the initiating device and responds with a transmission to the initiating device, e.g. a UE receiving an uplink grant and transmitting the corresponding PUSCH. As will be appreciated a UE can also be an initiating device, for example when it is transmitting a Configured Grant (CG) PUSCH, and the gNB can be a responding device.

There are two types of Dynamic Channel Access (DCA), which are referred to as Type 1 and Type 2. In a Type 1 DCA, a counter N is generated as a random number between 0 and CWₚ, where a Contention Window size CWₚ is set between CW_{min,p} and CW_{max,p}. The duration of the COT and the values {CW_{min,p}, CW_{max,p}} depend on the value p, which is the Channel Access Priority Class (CAPC) of the transmission. The CAPC may be determined, for example, by a QoS (quality of service) of the transmitting packet. A Type 1 DCA is performed by an initiating device, and once the COT is acquired, one or more responding devices can use Type 2 DCA for their transmissions within the COT. Type 2 DCA may require a short CCA or no CCA prior to transmission if the gap between one transmission of two devices is less than a predefined value, such as, for example, 25 μs. If the gap is greater than this predefined value, such as 25 μs, then the responding device needs to perform Type 1 DCA.

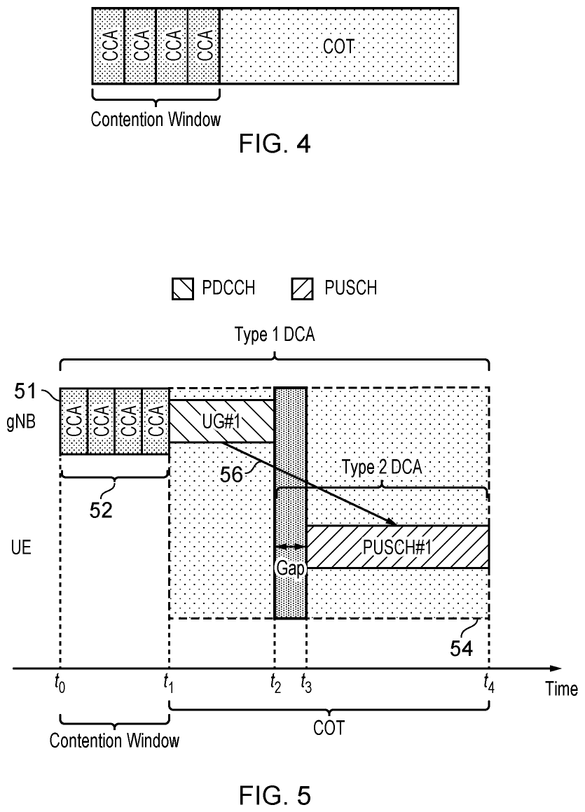

FIG. 5 provides an illustration of frequency against time for transmission in an unlicensed band. As shown for the example of FIG. 5, an example of a Type 1 DCA transmission and an example of a Type 2 DCA transmission are shown. According to the example shown in FIG. 5, at time to, the gNB wishes to send an uplink grant, UG #1, to the UE to schedule PUSCH #1. The gNB performs a Type 1 DCA starting with a Contention Window with four CCAs 51, so that for this example, the random number N=4, and detects no energy during this Contention Window 52, thereby acquiring the COT 54 between time t₁ and t₄. The gNB then transmits UG #1 to the UE scheduling a PUSCH #1 at time t₃ as represented by arrow 56. The UE receiving the uplink grant UG #1 can then use Type 2 DCA if the gap between UG #1 and the start of its PUSCH #1 transmission, between time t₂ and t₃ is below a threshold, otherwise the UE will have to perform a Type 1 DCA. This is to say, if the granted PUSCH #1 is less than a threshold time from the gNB's transmission of the uplink grant UG #1 or other gNB transmissions, then the UE is not required to make a contention itself for the resources on the unlicensed band by transmitting in the CCA and then COT according to the Type 1 DCA.

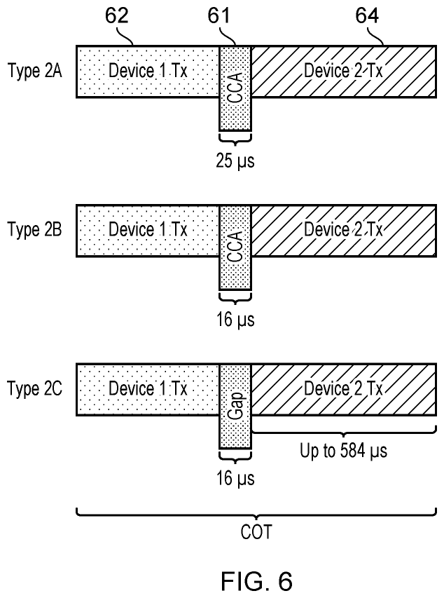

There are three types of Type 2 DCA, as shown in FIG. 6, which are defined with respect to a length of the gap 61 between transmission 62 by a first device (initiating device) and transmission 64 by a second device (responding device) within a COT, and are therefore defined by whether the second responding device needs to perform a CCA. These types are:
Type 2A: The gap between two transmissions is more than 16 μs and not more than 25 μs and the UE performs a single clear channel assessment (CCA) within this gap 61;
Type 2B: The gap between two transmissions is not more than 16 μs and the UE performs a single CCA within this gap 61; and
Type 2C: The gap between two transmissions is not more than 16 μs no CCA is required within this gap 61.

A COT can be shared by multiple devices; i.e. a gNB can initiate the COT which it can then share with one or more UEs. For example, a gNB can initiate a COT, and then can transmit an UL Grant to a UE, and the UE can then use this COT to transmit the PUSCH. A device using a COT initiated by another device may not need to perform CCA or may need to perform just a short CCA. Those skilled in the art would appreciate that a UE can also initiate a COT.

A device such as a gNB or a UE can initiate a COT, by performing a CCA phase, which includes an LBT, and if passed, allows the device access to the communications resources of an unlicensed channel according to the COT. The device, which initiates a COT, by performing the CCA phase, and transmitting in the COT is said to “own” the COT and it is known as an initiating device. The initiating device therefore performs the CCA phase and then transmits in the unlicensed channel according to its COT. The initiating device can transmit to another device (e.g. a message) and that other device can respond back (e.g. a HARQ-ACK feedback). The device responding back is a responding device. A gNB that has initiated a COT, thereby owning it, can schedule one or more other UEs to transmit PUSCHs at the same time where these multiple UEs are responding devices and they do not own the COT. As such, only one device owns the COT at a time but multiple devices can transmit in the unlicensed channel according to the initiating device's COT. Therefore the device does not need to own the COT to transmit in the unlicensed channel, where it is transmitting in response to a received grant or providing feedback to a received message. Thus more than device can transmit in the device owner's COT. Ownership of the COT means that the device owning the COT controls access of the communications resource of the COT.

Semi-Static Channel Access

There are various ways in which resources can be allocated to a UE for uplink and downlink transmissions. One example is a dynamic grant of resources. In a dynamic grant a UE typically sends a scheduling request in which the UE more conventionally transmits a PUCCH message, requesting uplink resources, based for example on a status of its input buffer, and receives via Downlink Control Information (DCI) from the gNB an indication of granted resources of an uplink shared channel. For regular periodic traffic a configured grant can be used to allocate resource more efficiently. A configured grant of resources provides an arrangement in which the UE exchanges RRC signalling messages with the gNB and is allocated resources of the uplink periodically for a certain period, where the allocation is referred to as being semi-static, whether or not it uses those resources.

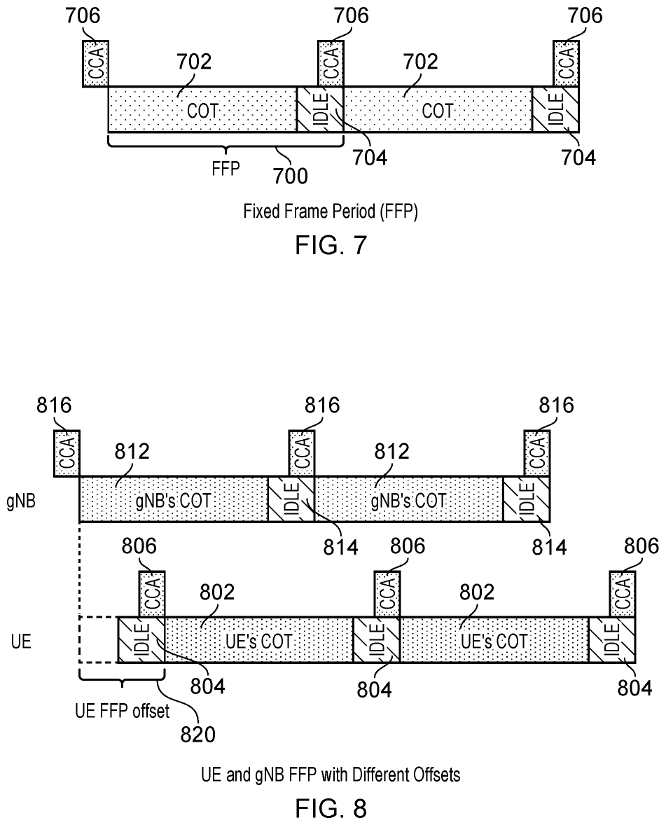

For the allocation of resources on an unlicensed carrier (NR-U), a Semi-static Channel Access (SCA) has been proposed (SCA). In SCA a Fixed Frame Period (FFP) is defined for COT acquisition and transmission. As shown in FIG. 7, an FFP 700 consists of a COT period 702 and an Idle period 704 at the end of each COT period 702. A CCA phase 706, which provides a listen before talk (LBT) facility as explained above, is required prior to an initiation of a COT. The CCA phase 706 is located contemporaneously with the Idle period 704, although it has a different temporal length. It has been proposed to define the FFP 700 for the gNB, with parameters defining its location, such as an offset, relative to start of radio frame SFN=0, and a time period (duration of the FFP), where such parameters may be configurable and broadcast to UEs within the cell served by the gNB in System Information Blocks (SIB), such as SIB1. The configurable FFP parameters can be reconfigured every 200 ms. This means that the gNB must maintain the FFP configuration for at least 200 ms before it can be reconfigured (if required).

In the diagrams of FIGS. 7 to 18 where the CCA phase is shown as a separate block above the channel of communications resource of an unlicensed band, the separate block is provided to represent an operating phase rather than a separate channel. The CCA phase 706 therefore comprises a period of time during which a gNB or a UE listens to the unlicensed channel for its COT, by performing a LBT.

Semi-static Channel Access is used in a controlled environment where the deployed unlicensed network is not expected to be interfered with by another unlicensed system. For example, an unlicensed network is deployed using SCA in a factory where the use of other unlicensed systems such as Wi-Fi is not allowed. In such an environment, the FFP of each gNB in the network can be aligned and synchronized.

It has been proposed (for 3GPP Release-17) that a UE can initiate a COT for a Semi-static Channel Access (SCA) in which the UE can operate with a different FFP offset to that of the gNB. An example where a UE and a gNB are communicating via an SCA, in which parameters of the FFP for each of the UE and the gNB result in a shift in alignment caused, for example by different offsets with respect to a start frame, is shown in FIG. 8. As shown in FIG. 8, an FFP for the UE comprises a COT 802 and an idle period 804 with a CCA 806 located in the idle period 804. Correspondingly, an FFP for the gNB comprises a COT 812 and an idle period 814 with a CCA 816 located in the idle period 814. As shown in FIG. 8 the FFP of the gNB is not aligned with the FFP of the UE due to different FFP offset configurations, as represented by a UE FFP offset 820. However, in other examples the UE FFP offset 820 can be zero so that the FFP of the UE and the gNB are aligned. 3GPP is currently considering whether to also allow different FFP periods between the UE and gNB [5].

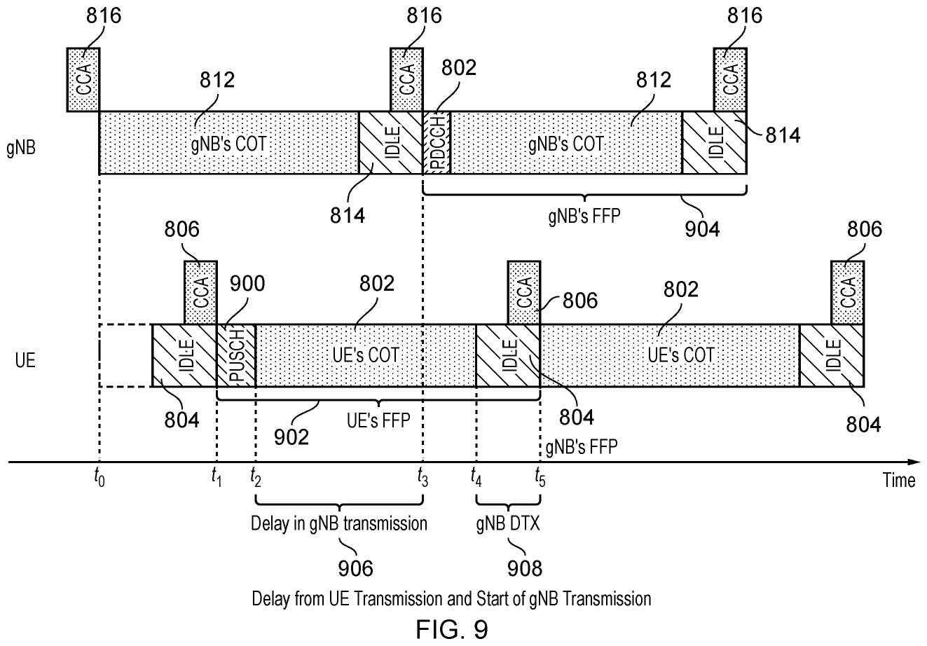

The UE FFP can be RRC configured and hence the offset and the period of the FFP are semi-static. However, the UE's uplink traffic for transmission may not require the entire duration of the acquired COT. That is to say, once the UE has been through the contentious access of an LBT by listening for other transmissions in a CCA phase, and acquired the COT, the UE may have completed its uplink transmission within the COT relatively early, thus not using the rest of the COT. Since the gNB can only acquire a COT at the beginning of its FFP, this may introduce delay between a gNB COT initiation and the end of the UE's transmission in the COT. An example is shown in FIG. 9 where the same reference numerals are used for the corresponding features shown in FIG. 8. As shown in FIG. 9, at time t₁, the UE transmits a PUSCH 900 after successfully passing the LBT in the CCA phase by listening to the channel thereby initiating a COT forming part of the UEs FFP 902. The COT 802 duration ends at time t₄ but the PUSCH transmission ends much earlier at time t₂. The gNB needs to transmit a PDCCH to schedule another UE but it can only initiate a COT at the start of the gNB's FFP 904 at time t₃. Hence this introduces delay 906 between the end of the UE's PUSCH at time t₂ and the start of the gNB's FFP at time t₃, which may not be acceptable for URLLC operation. Furthermore, the gNB may not be allowed to transmit in the idle period 804 of a UE initiated COT [5], which may introduce a further delay 908 to a gNB transmission. Using the example in FIG. 9, the gNB may not be able to transmit between time t₄ and t₅, which is during the UE's Idle Period since the UE had initiated the COT and therefore would be active in the UE's FFP 902.

A technical problem to address is therefore to reduce a delay between a UE's transmission in the UE initiated COT 802 and a gNB's transmission in the gNB's initiated COT 812.

Example embodiments can provide a method of operating a communications device (UE) as a release device releasing communications resources to other recipient devices. The method comprises determining that the UE can transmit data via an unlicensed channel comprising communications resources of a wireless access interface, which are shared in time with at least one of an infrastructure equipment (gNB) of a wireless communications network and one or more other UEs which can also transmit in the unlicensed channel. The transmission of the data on the unlicensed channel by the UE is arranged in time according to a fixed frame period (FFP) including a channel occupancy time (COT) for transmitting the data and an idle period. The determining that the UE can transmit the data on the unlicensed channel comprises detecting that none of the gNB and the one or more other UEs are transmitting in a CCA phase associated with a channel occupancy time (COT) of the UE's FFP, and, if none of the gNB and the one or more other UEs are transmitting in the CCA phase of the FFP, transmitting at least part of the data by the UE in the COT of the FFP on the unlicensed channel. The method includes determining that one or more portions of the COT of the FFP are unused by the UE before or after transmitting the at least part of the data, the data being transmitted via the one or more communications resources of the COT in a time which is less than a temporal length of the COT, and releasing at least one of the one or more portions of the COT which are unused for use by at least one of the gNB and the one or more other UEs.

Example embodiments can also provide a method of operating a gNB or a UE as a recipient device receiving released communications resources. For the gNB example, the method comprises determining that the gNB can transmit data via the unlicensed channel, communications resources of the unlicensed channel being shared with one or more other UEs which can also transmit in the communications resources of the unlicensed channel. The other UE arranges transmission of the data according to an FFP including a COT for transmitting the data and an idle period. The determining that the gNB can transmit the data on the communications resources of the unlicensed channel comprises detecting that the other UE, which has transmitted signals in a COT of an FFP of the other UE has released one or more portions of its COT, the other UE being a release device, the one or more portions of the unlicensed channel providing communications resources of the COT, which is unused before or after the other UE has transmitted its signals. The gNB is a recipient device, and the method includes transmitting, by the gNB as the recipient device, at least part of the data in one or more of the one or more portions of the COT of the FFP released by the release device. As mentioned above, one of the one or more other UEs could be a recipient device.

Embodiments can provide an arrangement in which a device that has initiated a COT can release its COT before the end of its FFP. The transmission of the data by UE can occupy part of the COT of the UE's FFP, which does not occupy a total temporal length (duration) of the COT, and so one or more portions are not used. The device can be a UE or a gNB, that is to say the technique is applicable for any device transmitting uplink or downlink signals. Embodiments can therefore provide an arrangement in which ownership of a COT can be passed for use by another device.

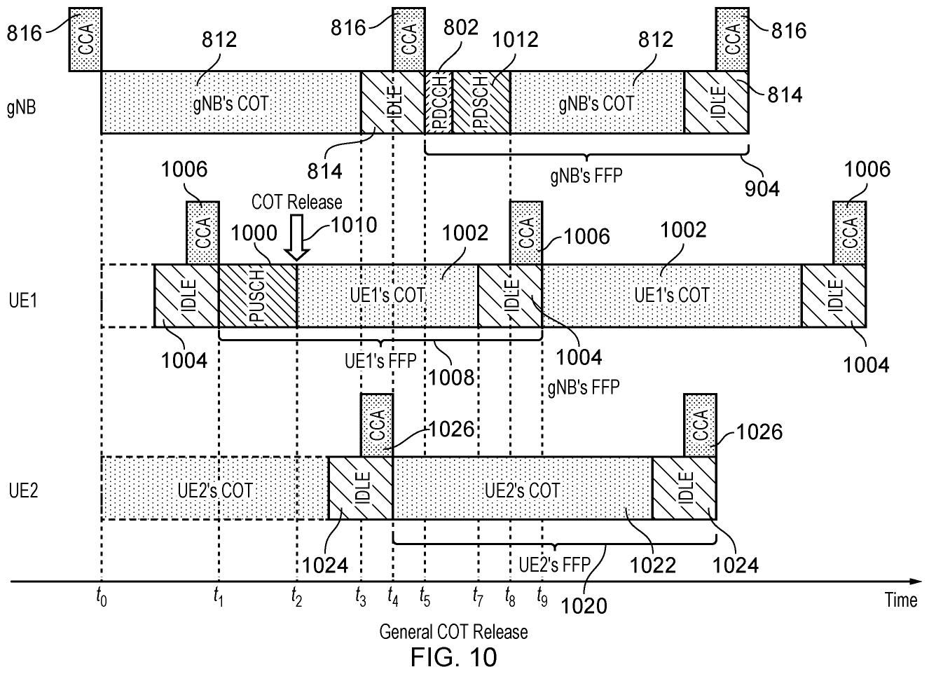

In an example embodiment, after a device has released its COT, other devices can seize the channel. Such a COT release by a device, which acquired shared time and frequency resources of a carrier or channel for transmission in its COT will be referred to in the following description as a “General COT Release”. In a General COT Release, other devices can contend for the channel that has been released by the device that initiated the COT. An example embodiment is shown in FIG. 10, in which corresponding features shown in FIGS. 8 and 9 have the same reference numerals. As shown in FIG. 10, a first UE, UE1, acquires a COT at time t₁ after passing the LBT during the CCA phase within the CCA 1006 and transmits a PUSCH 1000 between time t₁ and t₂ in the UE1's COT 1002 forming, in conjunction with an idle period 1004, its FFP 1008. After transmitting the PUSCH the UE releases its COT 1002, using an explicit indicator or via implicit indication 1010, as will be described in some example embodiments below. The communications resources of the channel can then be used by either the gNB or a second UE, UE2, which has its own FFP 1020 formed from a COT 1022 and an idle period 1024 and has an associated CCA 1026 as with the embodiments in FIGS. 8 and 9. In this example, the gNB acquires the channel using the CCA 816 and transmits its downlink transmissions via a PDCCH 802 and a PDSCH 1012 at time t₅.

For the example embodiments represented in FIGS. 10 to 18 below and indeed in the examples given in FIGS. 8 and 9, the gNB and the UE are accessing the same communications resources of a shared channel. Therefore, although the Figures show a vertical displacement of transmissions by a gNB and UEs, these transmissions are accessing the same communications resources in the frequency domain displaced in time so that any device cannot transmit at the same time as another device. As such a contentious access is required for those resources.

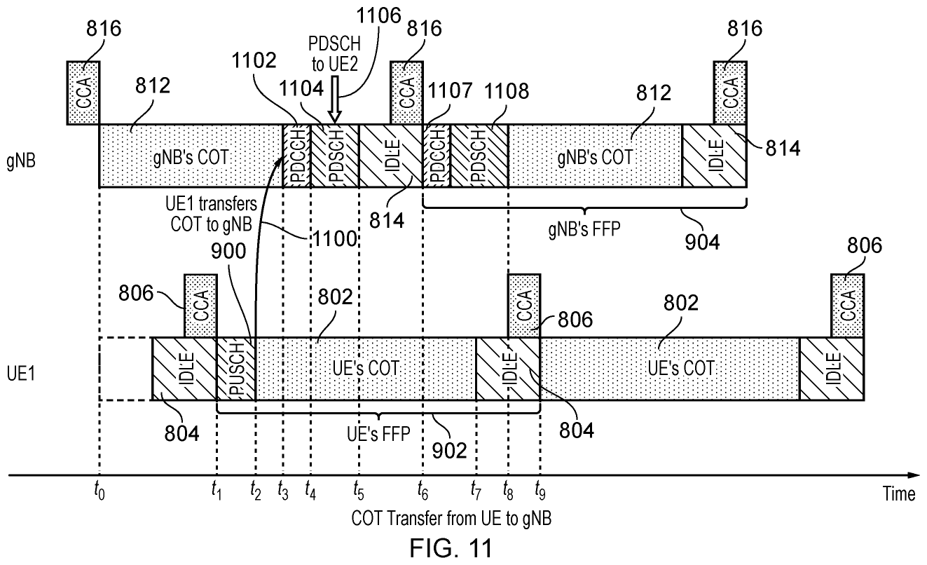

In another embodiment, the device that has acquired a COT can transfer the channel to another device. This can be viewed as a first device, which will be referred to as a Release Device, that has initiated a COT, transferring ownership or reservation of the COT to a second device, which is referred to as a Recipient Device. The second device can use the channel as if it had acquired or initiated the COT. This process of transferring a COT after use is referred to as COT Transfer, which is a transferring of COT ownership. There can be one or more Recipient Devices. An example is shown in FIG. 11 where the same reference numerals are used for the corresponding features shown in FIG. 10. As shown in FIG. 11, a UE1 initiates a COT at time t₁ and transmits a PUSCH 900 between time t₁ and t₂ after successfully passing the LBT in the CCA phase by listening in the CCA 806 thereby initiating a COT forming part of the UE1's FFP 902. However, unlike previous examples, after finishing its PUSCH transmission 900, UE1 releases its COT 802 and transfers its ownership of the COT 802 to the gNB at time t₂, as represented by an arrow 1100. The gNB receiving the COT has ownership of it and can transmit a downlink grant in a PDCCH 1102 to schedule a PDSCH transmission 1104 to a second UE, UE2, (not shown) in this example as represented by an arrow 1106.

At time t₆, the gNB initiates another COT, listening in the CCA 816 and transmits another downlink grant in the PDCCH 1107 to schedule another PDSCH transmission 1108. Since the UE, UE1, had released its COT 802, the PDSCH 1108 can be transmitted over the Idle Period 804 of UE1's previously initiated COT 802 of its FFP 902, between time t₇ to t₈ and within the gNB's FFP 904. It can therefore be appreciated that comparing the example shown in FIG. 11 with the example shown in FIG. 9, this embodiment removes or at least reduces a delay between the end of a UE's PUSCH transmission and the start of a gNB's transmission. Furthermore, since the UE had released its COT, another device, in this example the gNB, is able to transmit over the Idle Period 804 of the UE's COT. It will be appreciated that although the UE is the Release Device and the gNB is the Recipient Device in the example in FIG. 11, this example embodiment can be applied in other examples where another UE can be the Recipient Device or the gNB can be the Release Device.

FFP Adoption

The following embodiments describe an arrangement of which FFP timeframe the Recipient Device can use after the shared communications resources of the COT is transferred to it by a Release Device.

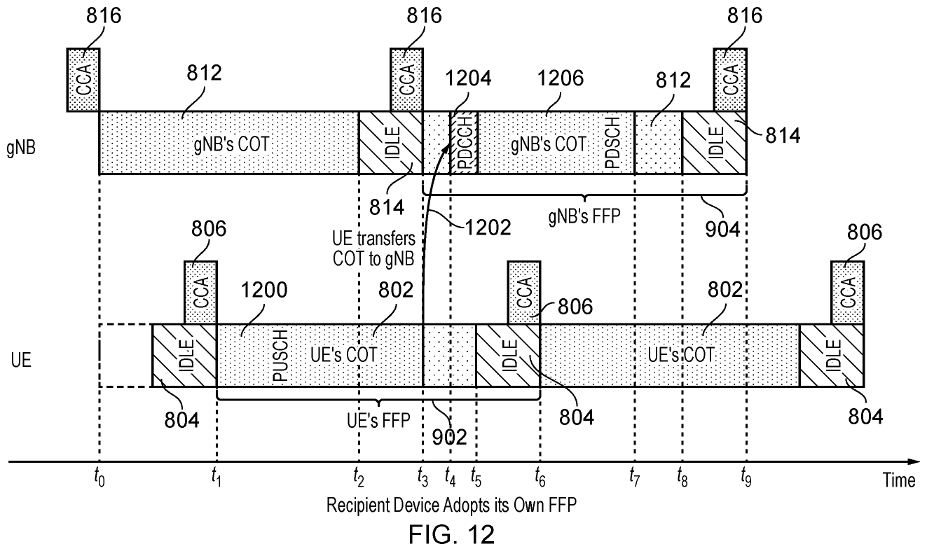

In an example embodiment, the Recipient Device adopts its own FFP after it has received ownership of the COT from the Release Device. An example is shown in FIG. 12, where the same reference numerals are used for the corresponding features shown in FIGS. 8 to 11. FIG. 12 corresponds to the example of FIG. 8 and so only the differences will be described. As shown in FIG. 12, a UE has initiated a COT 802 at time t₁ and transmits a PUSCH 1200 between time t₁ to t₃ as part of the UE's FFP 902. After the PUSCH transmission 1200, the UE transfers its COT to the gNB (i.e. the Recipient Device) at time t₃ as represented by an arrow 1202. The gNB then performs downlink transmissions where it adopts its own FFP 904, which in this example is between time t₃ to t₉, thereby allowing the gNB to occupy the COT 812 until time t₈ and transmitting a PDCCH 1204 to another UE followed by a PDSCH 1206. For this example, it should be noted that because the gNB is using its own FFP 904 there is an advantage of increasing an amount of resource available to the gNB. This is because, if the gNB were to adopt the UE's (Release Device) FFP 902, then the gNB would lose the transferred COT 802 at time t₅, which is the end of the UE's FFP 902 where the COT was initiated, whereas by allowing the gNB to use its own FFP 904, then the gNB can transmit to time t₈.

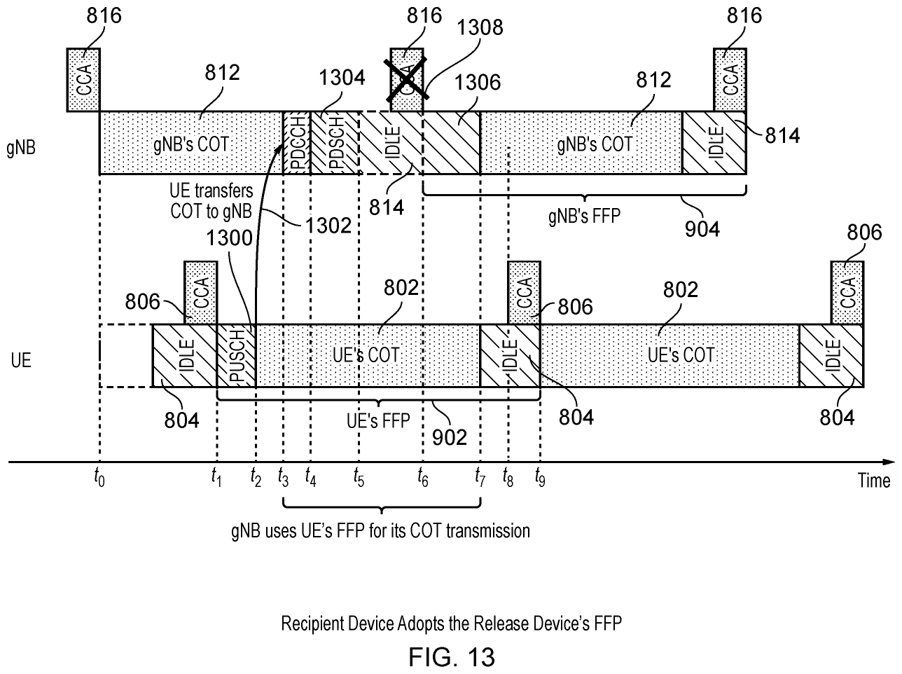

In another embodiment, the Recipient Device adopts the Release Device's FFP. An example is shown FIG. 13, where the same reference numerals are used for the corresponding features shown in FIGS. 10, 11 and 12. FIG. 13 corresponds to the example of FIG. 10 and so only the differences will be described. As shown in FIG. 13 the UE acquires a COT at time t₁ after listening to a CCA 806 and, after transmitting a PUSCH 1300 the UE transfers its COT to the gNB at time t₂ as represented by an arrow 1302. The gNB taking ownership of the UE's COT 802 transmits a PDCCH 1304 and a PDSCH 1306 where the transmission of the PDSCH 1306 ends at time t₇, which is the end of the FFP 902 of the UE (i.e. Release Device) that had initiated the COT. The PDSCH 1306 overlaps the Idle Period 814 of the gNB's FFP 904 between time t₅ and t₆ and extends towards the gNB's next FFP 904 between time t₆ and t₇, i.e. the gNB transmits over its own FFP's Idle Period 814. The gNB does not perform a CCA 816 forming part of its FFP 904 since it has adopted the UE's FFP 902, as represented by an X 1308.

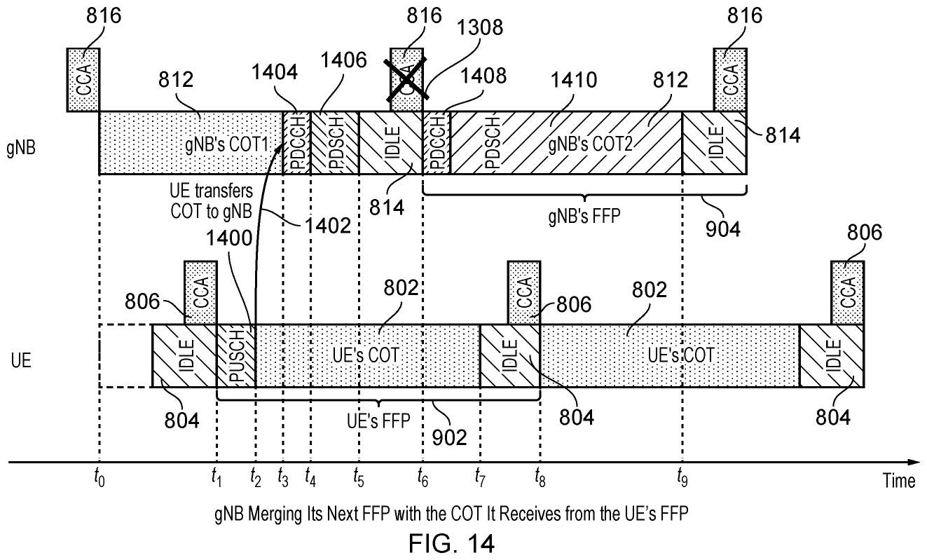

In another embodiment, a Recipient Device can merge its FFP with a transferred COT. This example is illustrated in FIG. 14, where the same reference numerals are used for the corresponding features shown in FIGS. 8 to 13. FIG. 14 corresponds to the example of FIG. 13 and so only the differences will be described. As shown in FIG. 14, a UE (Release Device) initiates a COT 802 at time t₁ (using the CCA 806 as described above) and after a PUSCH transmission 1400 at time t₂, the UE transfers the COT 802 to the gNB (Recipient Device) as represented by an arrow 1402. The gNB receiving the COT transmits until the end of its own COT period 812 belonging to its FFP 904. As shown in FIG. 14, the gNB merges its own COT1 of an FFP 904 and after the Idle Period between time t₅ and t₆, the gNB resumes transmissions until the end of its next COT 904, which is the gNB's second FFP COT2, at time t₉ without performing CCA, thereby merging its FFP (COT2) with the transferred COT (COT1). As indicated by an X 1308 the gNB does not need to perform a listen before talk (LBT) in the CCA 816. The gNB is therefore able to make PDCCH 1404, 1408 and PDSCH 1406, 1410 transmissions to other UEs.

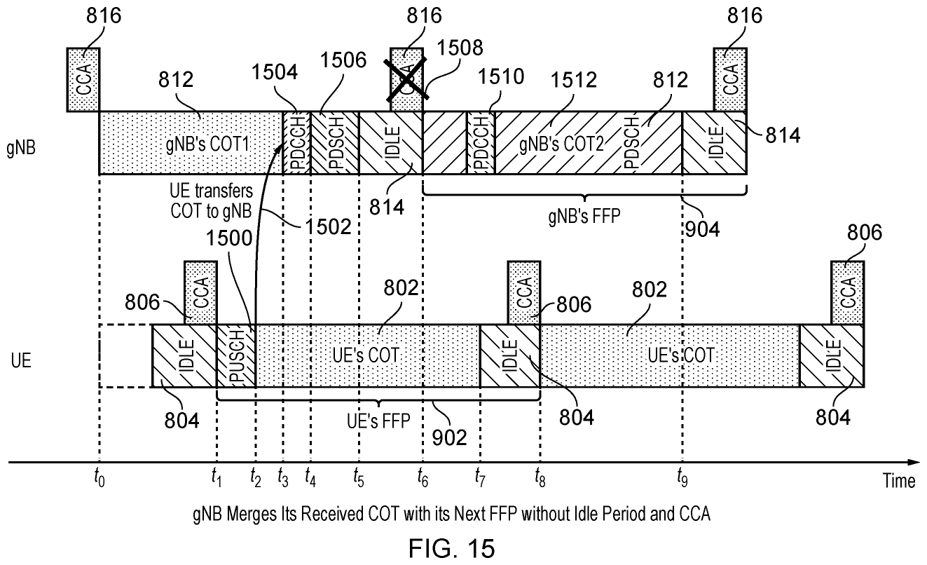

For the example shown in FIG. 14, the gNB adopts its own FFP timeframe 904 as per the previous embodiment in FIG. 13 and therefore obeys its FFP's Idle period 814. In another example embodiment, shown in FIG. 15, following a PUSCH transmission 1500 and transferring of the COT to the gNB as represented by an arrow 1502, the gNB, after receiving the COT, transmits a PDCCH 1504 and PDSCH 1506. In contrast to the example shown in FIG. 14, the gNB continues to transmit the PDSCH 1506 through and without any Idle period 814 to time t₇. The transmission of the PDSCH 1506 includes resources of the Idle period 814. Furthermore, the CCA 816 is not used as represented by an X 1508. The gNB can use the remaining portion of its COT 812 (gNB COT2) until the end of COT2 at time t₉ transmitting another PDCCH 1510 and a PDSCH 1512 to another UE or indeed the first UE. The example in FIG. 15 is where the gNB adopts the UE's FFP after receiving it and then continues with its own FFP.

In another embodiment, the Recipient Device can only merge FFPs that overlap with the Release Device's FFP where the COT was initiated. In the examples in FIGS. 14 and 15, the Release Device's FFP, i.e. the FFP of the UE where the COT is initiated, extends from time t₁ to t₈, hence overlapping two of the gNB's FFPs, which are labelled as COT1 and COT2, and so the gNB can merge these two FFPs.

In another embodiment the Recipient Device signals a “COT Token” to other devices to indicate that it has received the COT from the Release Device. This is to avoid other devices attempting to access the channel, especially for cases where the merged FFP contains an Idle Period between two transmissions. This embodiment is beneficial for the example embodiment of FIG. 14, where after the gNB receives the COT from the UE, it can transmit the said “COT Token”, via, for example, a broadcast channel, to other devices so that the other devices would not attempt to access the channel during the Idle Period between time t₅ and t₆. This “COT Token” can be transmitted, for example, using a DCI such as a GC-DCI.

Partial COT Release

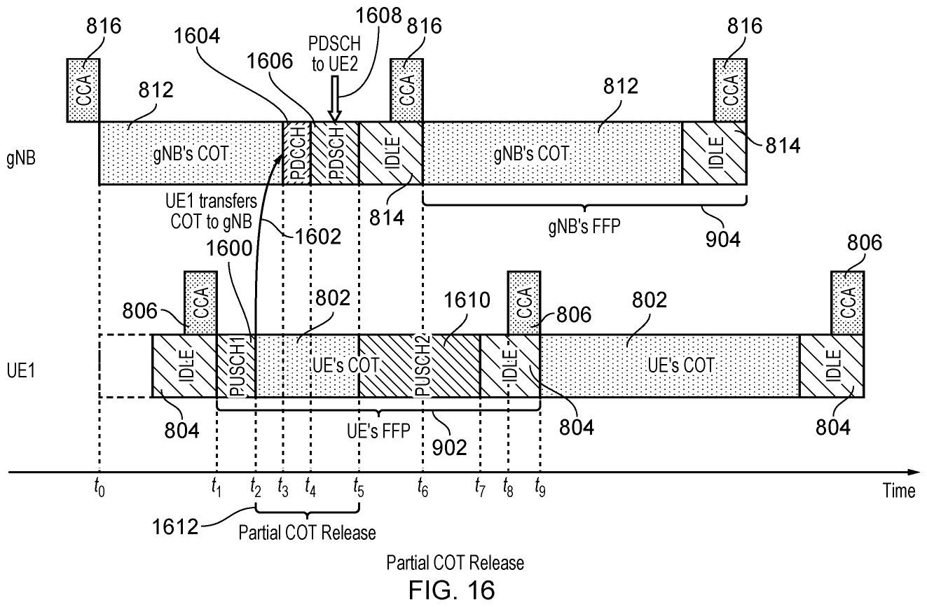

In another example embodiment, the Release Device releases only a portion of its COT and obtains its COT back after that release. The Release Device can indicate the specific portion of the COT it wants to release dynamically or the portion to be released can be RRC configured. An example embodiment is shown in FIG. 16. As above, features also appearing in FIGS. 11 to 15 have the same numerical designations. The embodiment illustrated in FIG. 16 is based on the other embodiments described above in FIGS. 11 to 15 and so only the differences will be described for brevity. In FIG. 16 a first UE, UE1, acquires a COT 802 at time t₁ and transmits PUSCH1 1600. After PUSCH1's transmission 1600, the UE transfers its COT 802 to the gNB, as represented by an arrow 1602, but only for the portion between time t₂ to t₅. A signalling message represented by the arrow 1602 indicates that not only is the COT transferred but also that it is transferred temporarily for the period between time t₂ to t₅. The gNB receiving the COT 802 then schedules a PDCCH transmission 1604 followed by a PDSCH transmission 1606 to a second UE, UE2, represented by an arrow 1608, after which it releases the COT 802 and the first UE, UE1, takes its COT back and transmits PUSCH2 between time t₅ to t₇. As illustrated by the example embodiment of FIG. 16, the first UE, UE1, therefore performs a partial release of the COT 802 acquired between time t₂ to t₅ as represented 1612.

Forced COT Release

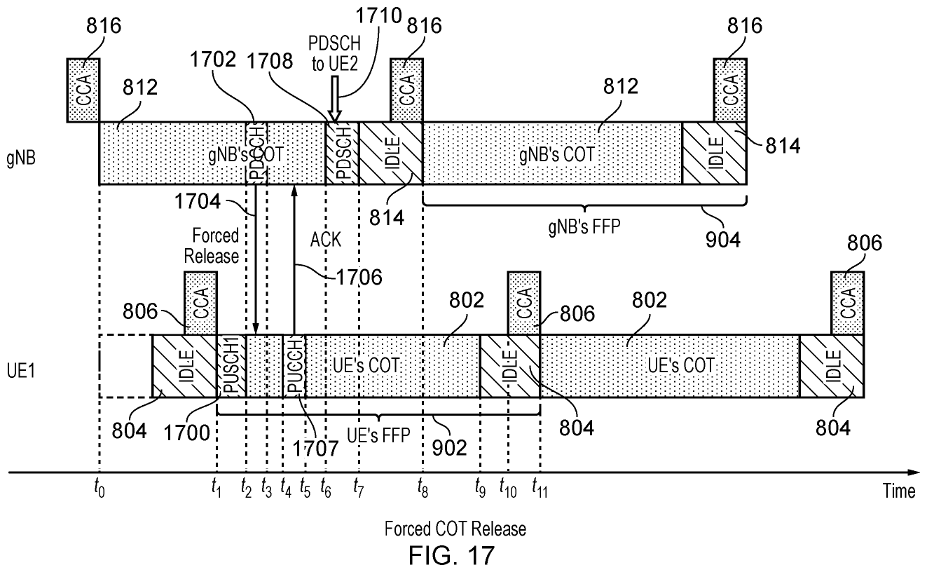

In another example embodiment, a Recipient Device can force a Release Device to release its COT, i.e. force the Release Device to give up its COT, which it has previously acquired by performing a listen before talk (LBT) in the CCA. A Release Device receiving a Force COT Release message can send an acknowledgement to the Recipient Device before releasing its COT. An example is shown in FIG. 17, which corresponds to the example embodiment of FIG. 16 and so only the differences will be described. In FIG. 17 a first UE, UE1, acquires a COT at time t₁ and transmits PUSCH1 1700. At time t₂, the gNB sends a signaling message as for example a DCI transmitted in a PDCCH 1702 to indicate to the UE that it should release the COT 802, which it previously acquired via the CCA 806. The signaling message represented by an arrow 1704 is therefore a Forced COT Release message. The first UE then transmits an ACK message 1706 in a PUCCH transmission 1707 at time t₄, acknowledging the Forced COT Release message 1704 and informing the gNB that the first UE has released its COT. The gNB then acquires the COT from the first UE and transmits a PDSCH 1708 to a second UE, UE2 at time t₆ as represented by an arrow 1710.

According to this example embodiment the Forced COT Release message 1704 is transmitted from the Recipient Device. For example:
For the case in which the Recipient Device is a gNB and the Release Device is a UE, this Forced COT Release message can be carried by a DCI or a GC-DCI;
For the case where the Recipient Device is a UE and the Release Device is a gNB, this Forced COT Release message can be sent in a UCI carried by a PUCCH or PUSCH.

According to this example embodiment the acknowledgement message 1706 to acknowledge a Forced COT Release is transmitted from a Release Device to a Recipient Device. For example:
For the case where the Release Device is a UE, this acknowledgement can be transmitted in a UCI carried by a PUCCH or PUSCH;
For the case where the Release Device is a gNB, this acknowledgement can be transmitted in a DCI or GC-DCI.

UE COT Release Indicator

As indicated above, according to example embodiments the COT release indication can be either explicit or implicit.

Explicit Indicators

In some example embodiments an explicit indicator is used to indicate the release of the COT by a Release Device. The explicit indicator can indicate one or more of the following COT Release types:
1. Indicates a General Release of the COT;
2. Indicates a COT Transfer to a specific Recipient Device, e.g. a UE transferring COT to the gNB;
3. Indicates a Partial COT Release and the specific portion of the COT to be released;
4. Indicates a COT Transfer to a group of Recipient Devices, e.g. to a group of UEs and these UEs can then contend for the COT;
5. Indicates a COT Transfer to other UEs by indicating to the gNB of such a transfer and the gNB then indicates to one or more UEs that can receive the COT. Here the gNB acts as an Intermediate Device.

Some examples of the explicit COT Release indicator can indicate a single COT Release type or it can indicate one or more different COT Release types. For example, a 1-bit field in a message can be used to indicate a General Release (e.g. value “0”) or a COT Transfer (e.g. value “1”). In another example a 2-bit or 3-bit indicator can be used to indicate one of the above COT release types.

In another embodiment, for the indication of a portion for Partial COT Release, the Release Device can indicate an offset O_{Release} from a start of its FFP and a duration L_{Release} for which the Release Device releases the FFP.

In another embodiment, for the indication of the portion for Partial COT Release, the Release Device can indicate an index to a lookup table which gives the offset O_{Release} and duration L_{Release}. An example lookup table is shown in Table 1, where Index 0 indicates Full Release, i.e. the COT is released without it being given back to the Release Device. Other indices give the offset in symbols from the start of the Release Device's FFP where the COT is initiated and the duration in symbols of the portion where the COT is released.

TABLE 1
Partial Release offset O_{Release} and duration L_{Release}.

| Index | O_{Release} | L_{Release} |
|---|---|---|
| 0 | Full Release | Full Release |
| 1 | 4 | 10 |
| 2 | 3 | 5 |
| 3 | 6 | 7 |

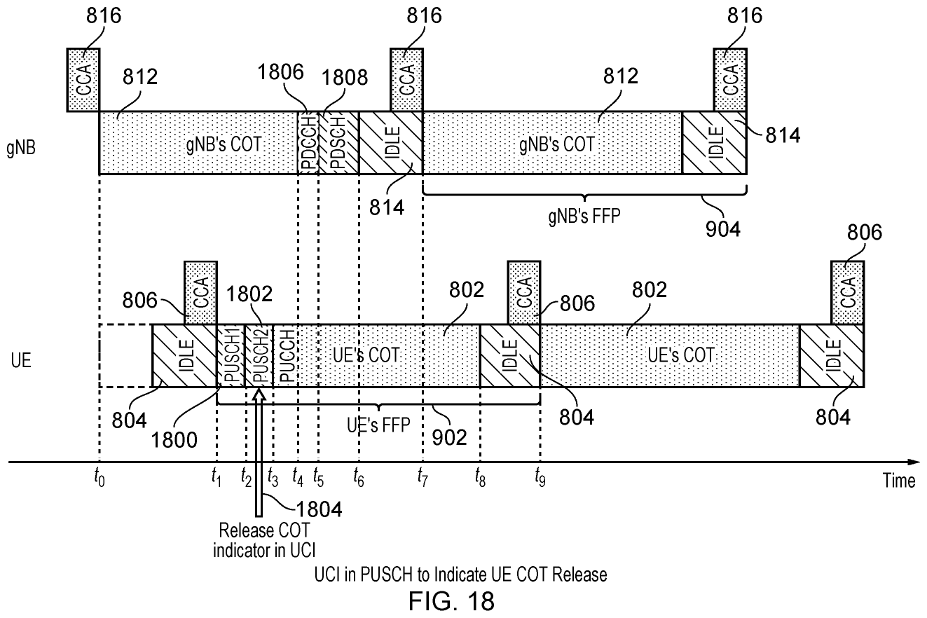

In another embodiment, an explicit COT Release indicator can form part of an Uplink Control Information (UCI) message. The UCI can be carried by a PUSCH or a PUCCH. An example embodiment is shown in FIG. 18, which corresponds to the examples shown in FIGS. 11 to 17 and so only the differences will be described. In FIG. 18, as for the other example embodiments shown in FIGS. 15, 16 and 17, a UE acquires a COT 802 at time t₁ and proceeds to transmit a PUSCH1 1800 and PUSCH2 1802. The UE attaches a UCI onto PUSCH2 1802 which provides an indication 1804 that the UE thereafter releases of its COT 802. The gNB, after receiving and detecting the indication 1804 in the UCI transmitted in the PUSCH2 1802, can then obtain ownership of the COT 802 sometime after t₃ and so at t₄ transmits a PDCCH 1806 followed by a PDSCH 1808 to another UE or the same UE between time t₄ to t₆. A new field can be introduced in the UCI or an existing field can be reinterpreted to indicate the UE's COT release 1804.

In another example embodiment, an explicit COT Release indicator can be provided in a Configured Grant-Uplink Control Information (CG-UCI) message, which is transmitted together with a CG-PUSCH. The CG-UCI can consist of the HARQ Process Number (HPN), Redundancy Version (RV), New Data Indicator (NDI) and COT Sharing Information fields as proposed for example in 3GPP NR Release-16. Further information on CG-PUSCH and CG-UCI is provided in [6] the contents of which are incorporated by reference. A new field can be added to a CG-UCI or an existing field can be reinterpreted to provide a COT Release indicator. The CG-UCI can also be transmitted within PUSCH of MsgA in 2-step RACH (Type-2 random access procedure).

In another example embodiment, an existing field in the CG-UCI is a COT Sharing Information field. A COT Release indicator can be indicated as an index in the “cg-COT-SharingList-r16” configuration, in which one or more of the entries indicate one or more different COT Release types as described above.

Further details on COT Sharing Information can be found in [6]. An example of the COT Sharing Information according to this example embodiment is shown in Table 2 for a 3-bit COT Sharing Information field. Here Indices 0, 3, 4 and 5 are used for the legacy COT Sharing purpose and the offset O_{DL} (in Slots) and L_{DL} (in Slots) are used to indicate the COT sharing portion. Indices 1 and 2 are used for COT Release where the COT is fully released. Indices 6 and 7 are used for Partial Release where the offset O_{Release} and duration L_{Release} are as given in the lookup table.

TABLE 2
COT Sharing Information index for COT
release (cg-COT-SharingList-r16)

| Index | O_{DL} or O_{Release} | L_{DL} or L_{Release} | Release/Share |
|---|---|---|---|
| 0 | No Sharing | No Sharing | N/A |
| 1 | Full Release | Full Release | General Release |
| 2 | Full Release | Full Release | COT Transfer |
| 3 | 2 | 4 | Sharing |
| 4 | 3 | 6 | Sharing |
| 5 | 2 | 7 | Sharing |
| 6 | 3 | 9 | Partial Release |
| 7 | 4 | 10 | Partial Release |

In another example embodiment, an explicit COT Release indicator can be carried by a PRACH. For example, this can be a predefined PRACH sequence.

In another example embodiment, an explicit COT Release indicator can be formed from a Sounding Reference Signal (SRS). The SRS is a sequence transmitted by the UE for channel sounding purposes and here a different sequence can be used to indicate one or more of the COT Release types mentioned above.

In another example embodiment, an explicit COT Release Indicator can be included in a Downlink Control Information (DCI) message. A DCI can be used where the gNB is the Release Device and the UE is the Recipient Device. A DCI can also be used where the gNB acts as an Intermediate Device for a UE to transfer its COT to another UE via the gNB. Here a first UE (Release Device) sends a COT Release indicator to the gNB and then the gNB uses a DCI to transfer the first UE's COT to a second UE.

In another example embodiment an explicit COT Release Indicator can be included in a GC-DCI. A GC-DCI can be used where a gNB is a Release Device or an Intermediate Device. The GC-DCI can provide the following:
Indication to a group of UEs so that they contend for the COT;
Indication to a group of UEs, where a specific order is signaled such that the UEs in this group take turns to take ownership of the COT.

In another example embodiment, an explicit COT Release indicator can be provided in a sidelink channel, for example a Physical Sidelink Shared Channel (PSSCH) or a Physical Sidelink Control Channel (PSCCH). A sidelink between two UEs can be used where the Release Device and Recipient Device are different UEs. Using a sidelink can avoid a need for an Intermediate Device, i.e. there is not a need for a gNB to pass the COT from one UE to another UE. This can be also beneficial when the Release UE and Recipient UE are aware of each other.

Implicit Indicators

In another example embodiment, the Release Device can implicitly indicate a COT Release, if the Release Device does not transmit for more than a certain predetermined period such as for example X ms, where X can be RRC configured, or dynamically indicated in a DCI or predetermined in the system specifications.

In another embodiment, a default Recipient Device is defined for a Release Device so that the default Recipient Device is aware of an implicit COT Release indication of the Release Device. For example, the default Recipient Device is a gNB and the Release Device is a UE that has initiated a COT. The gNB would then monitor for the implicit COT Release indication, for example a quiet period (DTX) of X ms from the UE.

In another example embodiment, a predefined Partial COT Release period can be used for the Recipient Device once it detects an implicit COT Release indicator. The Recipient Device then knows exactly when to take ownership of the COT and when to release it back to the original Release Device. This Partial COT Release period can be RRC configured or predetermined in system specifications.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a communications device, the method comprising
determining that the communications device can transmit data via one or more communications resources of an unlicensed channel of a wireless access interface, the communications resources of the unlicensed channel being shared in time with at least one of an infrastructure equipment of a wireless communications network and one or more other communications devices which can also transmit in the communications resources of the unlicensed channel, the transmission of the data by the communications device on the unlicensed channel being arranged in time according to a fixed frame period including a channel occupancy time for transmitting the data and an idle period, the determining that the communications device can transmit the data on the communications resources of the unlicensed channel including detecting that none of the infrastructure equipment and the one or more other communications devices are transmitting according to a clear channel assessment, CCA, phase associated with a channel occupancy time of a fixed frame period, and,
transmitting at least part of the data by the communications device in one or more of the communications resources of the channel occupancy time of the fixed frame period in the unlicensed channel, and the method includes
determining that one or more portions of the channel occupancy time of the fixed frame period are unused by the communications device, the time for transmitting at least part of the data in the channel occupancy time being less than a temporal length of the channel occupancy time, and
releasing the one or more portions of the channel occupancy time unused by the communications device as a release device to at least one of the infrastructure equipment and the one or more other communications devices as a recipient device.
   Paragraph 2. A method of paragraph 1, wherein the one or more portions of the channel occupancy time of the fixed frame period unused comprises a remaining portion of the channel occupancy time after the communications device has transmitted at least part of the data, and the method comprises
transmitting, by the communications device, to one of the infrastructure equipment and one of the one or more other communications devices an indication that the infrastructure equipment or the other one of the one or more communications devices can transmit in the remaining portion of the channel occupancy time of the fixed frame period unused by the communications device.
   Paragraph 3. A method of paragraph 1 or 2, wherein the releasing the one or more portions of the channel occupancy time unused by the communications device as a release device, comprises transmitting by the communications device as the release device an indication that the communications device is releasing a portion of the channel occupancy time of the fixed frame period that unused by the communications device to the infrastructure equipment or the one of the other communications devices as the recipient device, the communications device transmitting at least part of the data before or after the portion released.
   Paragraph 4. A method of paragraph 3, wherein the portion of the channel occupancy time released is determined dynamically and indicated by transmitting a release signal.
   Paragraph 5. A method of paragraph 3, wherein the portion of the channel occupancy time released is pre-configured using radio resource control signalling before the communications device transmits the data.
   Paragraph 6. A method of any of paragraphs 1 to 5, comprising
receiving a force release signal from one of the infrastructure equipment and one of the other communications devices, and the transmitting at least part of the data by the communications device in one or more of the communications resources of the channel occupancy time comprises
transmitting the at least part of the data by the communications device in the one or more communications resources of the channel occupancy time until the force release signal is received, the one or more portions of the channel occupancy time of the fixed frame period remaining unused by the communications device after the force release signal is received, and
transmitting an acknowledgement in response to the force release signal.
   Paragraph 7. A method of paragraph 1 or 2, comprising transmitting a release signal indicating the releasing of the one or more portions of the channel occupancy time unused by the communications device as the release device to the recipient device.
   Paragraph 8. A method of paragraph 1 or 2, comprising transmitting a release signal indicating that the communications device as the release device is releasing the portion of the channel occupancy time unused by the communications device after the transmission of the release signal.
   Paragraph 9. A method of paragraph 8, wherein the release signal provides an indication of the portion of the channel occupancy time unused by the communications device as an offset from a start of the fixed frame period and a duration of the portion of the remaining one or more communications resources.
   Paragraph 10. A method of paragraph 8, wherein the release signal provides an indication of a pre-configured index of a look-up table each index indicating a different offset from a start of the fixed frame period and a different duration of the portion of the channel occupancy time released by the communications device.
   Paragraph 11. A method of any of paragraphs 7 to 10, wherein the release signal identifies one of the infrastructure equipment or one of the one or more other communications devices to which the one or more remaining shared communications resources are being released.
   Paragraph 12. A method of paragraph 7 or 8, wherein the recipient device is one of the one or more other communications devices and the release signal is transmitted via a sidelink channel.
   Paragraph 13. A method of any of paragraphs 1 to 12, wherein the recipient device is defined as a default for the communications device acting as a release device.
   Paragraph 14. A method of operating a communications device to communicate using a wireless communications network, the method comprising
determining that the communications device can transmit data via one or more communications resources of an unlicensed channel of a wireless access interface, the communications resources of the unlicensed channel being shared in time with at least one of an infrastructure equipment of a wireless communications network and one or more other communications devices which can also transmit in the communications resources of the unlicensed channel, the transmission of the data by the communications device on the unlicensed channel being arranged in time according to a fixed frame period including a channel occupancy time for transmitting the data and an idle period, and the determining that the communications device can transmit the data on the communications resources of the unlicensed channel comprises
detecting that one of the infrastructure equipment and one of the one or more other communications devices, which has transmitted signals on the unlicensed channel in a channel occupancy time of a fixed frame period of the infrastructure equipment or the one other communications device has released one or more portions of the channel occupancy time of the fixed frame period which are unused by the infrastructure equipment or the one other communications device, the infrastructure equipment or the one other communications device being a release device, and the communications device being a recipient device, and the method includes
transmitting, by the communications device as the recipient device, at least part of the data in one or more of the released portions of the unlicensed channel from the channel occupancy time of the fixed frame period of the release device.
   Paragraph 15. A method of paragraph 14, wherein the transmitting, by the communications device as the recipient device, at least part of the data in the one or more released portions of the unlicensed channel from the channel occupancy time of the fixed frame period of the release device comprises transmitting at least part of the data by the communications device as the recipient device in the one or more communications resources of the unlicensed channel from a channel occupancy time of a fixed frame period of the communications device as the recipient device.
   Paragraph 16. A method of paragraph 14, wherein the transmitting, by the communications device as the recipient device, at least part of the data in the one or more released portions of the unlicensed channel comprises transmitting at least part of the data by the communications device as the recipient device in the one or more of the released portions according to the channel occupancy time of the fixed frame period of the release device, the fixed frame period of the release device including the channel occupancy time and an idle period.
   Paragraph 17. A method of paragraph 14, wherein the transmitting, by the communications device as the recipient device, at least part of the data in the one or more released portions of the unlicensed channel from the channel occupancy time of the fixed frame period of the release device, comprises transmitting the data by the communications device as the recipient device in the one or more released portions of the unlicensed channel from the channel occupancy time of the fixed frame period of the recipient device as one or more communications resources of a first fixed frame period of the recipient device and one or more communications resources of a channel occupancy time of a second fixed frame period of the recipient device, which second fixed frame period of the recipient device occurs as a next fixed frame period after the first fixed frame period.
   Paragraph 18. A method of paragraph 17, wherein the transmitting the data includes not transmitting the data in an idle period of the first or the second fixed frame period of the recipient device.
   Paragraph 19. A method of paragraph 17 or 18, wherein the transmitting the data includes transmitting the data without detecting whether one of the infrastructure equipment or one or more others of the communications devices as the release device transmits signals according to a clear channel assessment, CCA, phase of the unlicensed channel.
   Paragraph 20. A method of paragraph 14, wherein the transmitting, by the communications device as the recipient device, at least part of the data in the one or more released portions of the unlicensed channel from the channel occupancy time of the fixed frame period of the release device comprises transmitting the data by the communications device as the recipient device in the one or more released portions of the unlicensed channel from the channel occupancy time of the fixed frame period of the release device and one or more communications resources of a channel occupancy time of a fixed frame period of the communications device as the recipient device, which fixed frame period of the recipient device occurs as a next fixed frame period of the communications device to the fixed frame period of the release device, wherein the transmitting the data includes transmitting the data in an idle period of the fixed frame period of the communications device as the recipient communication device without detecting whether one of the infrastructure equipment or one or more others of the communications devices transmit signals according to a clear channel assessment, CCA, phase of the fixed frame period of the recipient device.
   Paragraph 21. A method of paragraph 14, wherein the transmitting, by the communications device as the recipient device, at least part of the data in one or more of the released portions of the unlicensed channel from the channel occupancy time of the fixed frame period of the release device, comprises detecting that one or more of the released portions of the unlicensed channel from the channel occupancy time of the fixed frame period of the release device overlaps with a channel occupancy time of a next fixed frame period of the communications device as a recipient device, and
if the channel occupancy time of the fixed frame period of the release device overlaps with the channel occupancy time of a next fixed frame period of the communications device as a recipient device, transmitting the data by the communications device as the recipient device in the one or more released portions of the unlicensed channel from the release device and one or more communications resources of the channel occupancy time of the next fixed frame period of the recipient device which merge with the communications resources of the one or more released portions of the unlicensed channel from the release device, or otherwise
only transmitting the at least part of the data by the communications device as the recipient device in the one or more communications resources of the one or more released portions of the unlicensed channel from the release device.
   Paragraph 22. A method of any of paragraphs 14 to 21, comprising transmitting by the communications device as the recipient device a COT token to the infrastructure equipment and one or more of the other communications devices as the release device indicating that the communications device has received and will transmit in the one or more communications resources of the one or more released portions of the unlicensed channel released by the release device.
   Paragraph 23. A method of any of paragraphs 14 to 22, wherein the detecting that the release device has released the one or more portions of the channel occupancy time comprises receiving an indication from the release device that the release device is releasing a portion of the communications resources of the channel occupancy time to the communications devices as the recipient device.
   Paragraph 24. A method of paragraph 23, wherein the portion of the unlicensed channel from the channel occupancy time released by the release device is determined dynamically from a portion of the channel occupancy time of the fixed frame period of the release device which remains after the release device has transmitted the signals, the portion being indicated by a signal received from the release device.
   Paragraph 25. A method of paragraph 23, wherein the portion of the channel occupancy time of the fixed frame period of the release device released is pre-configured using radio resource control signalling before the communications device transmits the data.
   Paragraph 26. A method of paragraph 14, comprising
detecting that the release device is transmitting signals in the one or more communications resources of the unlicensed channel from the channel occupancy time of the fixed frame period of the release device,
transmitting a force release signal to the release device, and the detecting that the release device has released the one or more released portions of the channel occupancy time of the fixed frame period of the release device comprises
receiving an acknowledgement in response to the force release signal, the one or more portions of the unlicensed channel from channel occupancy time of the fixed frame period released by the release device being the one or more communications resources of the unlicensed channel remaining of the channel occupancy time when the acknowledgement is received by the communications device as the recipient communication device.
   Paragraph 27. A method of paragraph 14 or 15, comprising receiving a release signal indicating that the one or more portions of the unlicensed channel from the channel occupancy time of the release device are released to the recipient device.
   Paragraph 28. A method of any of paragraphs 23 to 25, comprising receiving a release signal indicating that the release device is releasing the portion of the channel occupancy time unused by the release device after the transmission of the release signal.
   Paragraph 29. A method of paragraph 28, wherein the release signal provides an indication of the portion of the channel occupancy time released by the release device as an offset from a start of the fixed frame period and a duration of the portion of the channel occupancy time released.
   Paragraph 30. A method of paragraph 28, wherein the release signal provides an indication of a pre-configured index of a look-up table each index indicating a different offset from a start of the fixed frame period and a different duration of the portion of the channel occupancy time released by the release device.
   Paragraph 31. A method of any of paragraphs 27 to 30, wherein the release signal identifies the communications device as a recipient device.
   Paragraph 32. A method of paragraph 27 or 28, wherein the receiving a release signal comprises receiving the release signals from the release device via a sidelink interface between the communications device as recipient device and the release device is another communications device.
   Paragraph 33. A method of any of paragraphs 14 to 32, wherein the detecting that the release device has released one or more communications resources of the unlicensed channel from the one or more released portions of the channel occupancy time of the fixed frame period comprises
detecting, by the communications device as a recipient device, that the release device has not transmitted signals in the communications resources of the unlicensed channel for a configured period, the configured period being a period for which the release device has not transmitted in its channel occupancy time.
   Paragraph 34. A method of paragraph 33, wherein the configured period is indicated by radio resource control signalling.
   Paragraph 35. A method of operating an infrastructure equipment of a wireless communications network to communicate with one or more communications devices, the method comprising
determining that the infrastructure equipment can transmit data via one or more communications resources of an unlicensed channel of a wireless access interface, the communications resources of the unlicensed channel being shared in time with one or more other communications devices which can also transmit in the communications resources of the unlicensed channel, the transmission of the data by the infrastructure equipment on the unlicensed channel being arranged in time according to a fixed frame period including a channel occupancy time for transmitting the data and an idle period, and the
determining that the infrastructure equipment can transmit the data on the communications resources of the unlicensed channel comprises detecting that one of the one or more other communications devices, which has transmitted signals on the unlicensed channel in a channel occupancy time of a fixed frame period of the other communications device has released one or more portions of the channel occupancy time of the fixed frame period which are unused by the one other communications device, the other communications device being a release device, and the infrastructure equipment being a recipient device, and the method includes
transmitting, by the infrastructure equipment as the recipient device, at least part of the data in one or more of the released portions of the unlicensed channel from the channel occupancy time of the fixed frame period of the release device.
   Paragraph 36. A method of paragraph 35, wherein the transmitting, by the infrastructure equipment as the recipient device, at least part of the data in the one or more released portions of the unlicensed channel from the channel occupancy time of the fixed frame period of the release device comprises transmitting at least part of the data by the infrastructure equipment as the recipient device in the one or more communications resources of the unlicensed channel from a channel occupancy time of a fixed frame period of the infrastructure equipment as the recipient device.
   Paragraph 37. A method of paragraph 35, wherein the transmitting, by the infrastructure equipment as the recipient device, at least part of the data in one or more of the released portions of the unlicensed channel from the channel occupancy time of the fixed frame period of the release device comprises transmitting at least part of the data by the infrastructure equipment as the recipient device in the one or more of the released portions according to the channel occupancy time of the fixed frame period of the release device, the fixed frame period of the release device including the channel occupancy time and an idle period.
   Paragraph 38. A method of paragraph 35, wherein the transmitting, by the infrastructure equipment as the recipient device, at least part of the data in one or more of the released portions of the unlicensed channel from the channel occupancy time of the fixed frame period of the release device, comprises transmitting the data by the infrastructure equipment as the recipient device in the one or more of the released portions of the unlicensed channel as one or more communications resources of a channel occupancy time of a first fixed frame period of the infrastructure equipment as the recipient device and one or more communications resources of a channel occupancy time of a second fixed frame period of the infrastructure equipment, which second fixed frame period of the infrastructure equipment occurs as a next fixed frame period to the first fixed frame period of the recipient device.
   Paragraph 39. A method of paragraph 38, wherein the transmitting the data includes not transmitting the data in an idle period of the first or the second fixed frame period of the infrastructure equipment as the recipient communication device.
   Paragraph 40. A method of paragraph 38 or 39, wherein the transmitting the data includes transmitting the data without detecting whether the other communications devices as the release device transmits signals in a clear channel assessment, CCA, phase of the unlicensed channel.
   Paragraph 41. A method of paragraph 35, wherein the transmitting, by the infrastructure equipment as the recipient device, at least part of the data in the one or more released portions of the unlicensed channel from the channel occupancy time of the fixed frame period of the release device comprises transmitting the data by the infrastructure equipment as the recipient device in the one or more released portions according to the channel occupancy time of the fixed frame period of the release device and one or more communications resources of a channel occupancy time of a fixed frame period of the infrastructure equipment as the recipient device, which fixed frame period occurs as a next fixed frame period of the infrastructure equipment to the fixed frame period of the release device, wherein the transmitting the data includes transmitting the data in an idle period of the fixed frame period of the infrastructure equipment as the recipient communication device without detecting whether one of the other communications devices transmit signals according to a clear channel assessment, CCA, phase of the unlicensed channel.
   Paragraph 42. A method of paragraph 35, wherein the transmitting, by the infrastructure equipment as the recipient device, at least part of the data in one or more of the released portions of the unlicensed channel from the channel occupancy time of the fixed frame period of the release device, comprises detecting that one or more of the released portions of the unlicensed channel from the channel occupancy time of the fixed frame period of the release device overlaps with a channel occupancy time of a next fixed frame period of the infrastructure equipment as a recipient device, and
if the channel occupancy time of the fixed frame period of the release device overlaps with the channel occupancy time of a next fixed frame period of the infrastructure equipment as a recipient device, transmitting the data by the infrastructure equipment as the recipient device in the one or more released portions of the unlicensed channel from the release device and one or more communications resources of the channel occupancy time of the next fixed frame period of the recipient device which merge with the communications resources of the one or more released portions of the unlicensed channel from the release device, or otherwise
only transmitting the at least part of the data by the infrastructure equipment as the recipient device in the one or more communications resources of the one or more released portions of the unlicensed channel from the release device.
   Paragraph 43. A method of any of paragraphs 35 to 42, comprising transmitting by the infrastructure equipment as the recipient device a COT token to the other communications device as the release device indicating that the infrastructure equipment has received and will transmit in the one or more communications resources of the one or more released portions of the unlicensed channel released by the release device.
   Paragraph 44. A method of any of paragraphs 35 to 43, wherein the detecting that the release device has released the one or more portions of the channel occupancy time comprises receiving an indication from the release device that the release device is releasing a portion of the communications resources of the channel occupancy time to the infrastructure equipment as the recipient device.
   Paragraph 45. A method of paragraph 44, wherein the portion of the unlicensed channel from the channel occupancy time released by the release device is determined dynamically from a portion of the channel occupancy time of the fixed frame period of the release device which remains after the release device has transmitted the signals, the portion being indicated by a signal received from the release device.
   Paragraph 46. A method of paragraph 35, comprising
detecting that the release device is transmitting signals in the one or more communications resources of the unlicensed channel from the channel occupancy time of the fixed frame period of the release device,
transmitting, by the infrastructure equipment, a force release signal to the release device, and the detecting that the release device has released the one or more released portions of the channel occupancy time of the fixed frame period of the release device comprises
receiving an acknowledgement in response to the force release signal, the one or more portions of the unlicensed channel from channel occupancy time of the fixed frame period released by the release device being the one or more communications resources of the unlicensed channel remaining of the channel occupancy time when the acknowledgement is received by the infrastructure equipment as the recipient device.
   Paragraph 47. A method of paragraph 35 or 36, comprising receiving a release signal indicating that the one or more portions of the unlicensed channel from the channel occupancy time of the release device are released to the recipient device.
   Paragraph 48. A method of any of paragraphs 35 to 36, comprising receiving a release signal indicating that the release device is releasing the portion of the channel occupancy time released by the release device after the transmission of the release signal.
   Paragraph 49. A method of paragraph 48, wherein the release signal provides an indication of the portion of the channel occupancy time released by the release device as an offset from a start of the fixed frame period and a duration of the portion of the channel occupancy time released.
   Paragraph 50. A method of paragraph 48, wherein the release signal provides an indication of a pre-configured index of a look-up table each index indicating a different offset from a start of the fixed frame period and a different duration of the portion of the channel occupancy time released by the release device.
   Paragraph 51. A method of any of paragraphs 47 to 50, wherein the release signal identifies the infrastructure equipment as a recipient device.
   Paragraph 52. A method of any of paragraphs 35 to 51, wherein the detecting that the release device has released one or more communications resources of the unlicensed channel from the one or more released portions of the channel occupancy time of the fixed frame period comprises
detecting, by the infrastructure equipment as a recipient device, that the release device has not transmitted signals in the communications resources of the unlicensed channel for a configured period, the configured period being a period for which the release device has not transmitted in its channel occupancy time.
   Paragraph 53. A communications device comprising
transmitter circuitry configured to transmit signals via communications resources of an unlicensed channel of a wireless access interface, the communications resources of the unlicensed channel being shared in time with at least one of an infrastructure equipment of a wireless communications network and one or more other communications devices which can also transmit in the communications resources of the unlicensed channel at different times,
receiver circuitry configured to receive signals transmitted via the communications resources of the unlicensed channel, and
controller circuitry configured to control the transmitter circuitry and the receiver circuitry, the controller circuitry being configured with the receiver circuitry
to determine that the transmitter circuitry can transmit data via one or more of the communications resources of the unlicensed channel according to a fixed frame period, including a channel occupancy time for transmitting the data and an idle period, by detecting that none of the infrastructure equipment and the one or more other communications devices are transmitting according to a clear channel assessment, CCA, phase associated with a channel occupancy time of a fixed frame period, and to control the transmitter circuitry to transmit at least part of the data in one or more of the communications resources of the channel occupancy time of the fixed frame period in the unlicensed channel, wherein the controller circuitry is configured
to determine that one or more portions of the channel occupancy time of the fixed frame period are unused by the communications device, the time for transmitting at least part of the data in the channel occupancy time being less than a temporal length of the channel occupancy time, and
to release the one or more portions of the channel occupancy time unused by the communications device as a release device, the one or more portions being released to at least one of the infrastructure equipment and the one or more other communications devices as a recipient device.
   Paragraph 54. A communications device comprising
transmitter circuitry configured to transmit signals via communications resources of an unlicensed channel of a wireless access interface, the communications resources of the unlicensed channel being shared in time with at least one of an infrastructure equipment of a wireless communications network and one or more other communications devices which can also transmit in the communications resources of the unlicensed channel at different times,
receiver circuitry configured to receive signals transmitted via the communications resources of the unlicensed channel, and
controller circuitry configured to control the transmitter circuitry and the receiver circuitry, the controller circuitry being configured with the receiver circuitry
to determine that the communications device can transmit data via one or more of the communications resources of the unlicensed channel arranged in time according to a fixed frame period, including a channel occupancy time for transmitting the data and an idle period, by detecting that, one of the infrastructure equipment and one of the one or more other communications devices which has transmitted signals on the unlicensed channel in a channel occupancy time of a fixed frame period of the infrastructure equipment or the one other communications device, has released one or more portions of the channel occupancy time of the fixed frame period which are unused by the infrastructure equipment or the one other communications device, the infrastructure equipment or the one other communications device being a release device, and the communications device being a recipient device, and the controller circuitry is configured with the transmitter circuitry
to transmit at least part of the data in one or more of the released portions of the unlicensed channel from the channel occupancy time of the fixed frame period of the release device.
   Paragraph 55. An infrastructure equipment of a wireless communications network for communicating with one or more communications devices, the infrastructure equipment comprising
transmitter circuitry configured to transmit signals via communications resources of an unlicensed channel of a wireless access interface, the communications resources of the unlicensed channel being shared in time with one or more other communications devices which can also transmit in the communications resources of the unlicensed channel,
receiver circuitry configured to receive signals transmitted via the communications resources of the unlicensed channel, and
controller circuitry configured to control the transmitter circuitry and the receiver circuitry, the controller circuitry being configured with the receiver circuitry
to determine that the transmitter circuitry can transmit data via one or more of the communications resources of the unlicensed channel arranged in time according to a fixed frame period, including a channel occupancy time for transmitting the data and an idle period, the controller circuitry being configured to determine that the transmitter circuitry can transmit by detecting that one of the one or more other communications devices, which has transmitted signals on the unlicensed channel in a channel occupancy time of a fixed frame period of the other communications device has released one or more portions of the channel occupancy time of the fixed frame period which are unused by the other communications device, the other communications device being a release device, and the infrastructure equipment being a recipient device, and the controller circuitry is configured with the transmitter circuitry
to transmit at least part of the data in one or more of the released portions of the unlicensed channel from the channel occupancy time of the fixed frame period of the release device.
   Paragraph 56. An infrastructure equipment of a wireless communications network for communicating with one or more communications devices, the infrastructure equipment comprising
transmitter circuitry configured to transmit signals via communications resources of an unlicensed channel of a wireless access interface, the communications resources of the unlicensed channel being shared in time with one or more other communications devices which can also transmit in the communications resources of the unlicensed channel at different times,
receiver circuitry configured to receive signals transmitted via the communications resources of the unlicensed channel, and
controller circuitry configured to control the transmitter circuitry and the receiver circuitry, the controller circuitry being configured with the receiver circuitry
to determine that the transmitter circuitry can transmit data via one or more of the communications resources of the unlicensed channel according to a fixed frame period, including a channel occupancy time for transmitting the data and an idle period, by detecting that none of the one or more communications devices is transmitting according to a clear channel assessment, CCA, phase associated with a channel occupancy time of a fixed frame period, and,
if none of the communications devices is transmitting in the CCA phase associated with the channel occupancy time of the fixed frame period, to control the transmitter circuitry to transmit at least part of the data in one or more of the communications resources of the channel occupancy time of the fixed frame period in the unlicensed channel, wherein the controller circuitry is configured
to determine that one or more portions of the channel occupancy time of the fixed frame period remain unused by the infrastructure equipment, the time for transmitting at least part of the data in the channel occupancy time being less than a temporal length of the channel occupancy time, and
to release the one or more portions of the channel occupancy time unused by the infrastructure equipment as a release device, the one or more portions being released to the one or more other communications devices as a recipient device.
   Paragraph 57. Circuitry of a user equipment comprising
transmitter circuitry configured to transmit signals via communications resources of an unlicensed channel of a wireless access interface, the communications resources of the unlicensed channel being shared in time with at least one of an infrastructure equipment of a wireless communications network and one or more other communications devices which can also transmit in the communications resources of the unlicensed channel at different times,
receiver circuitry configured to receive signals transmitted via the communications resources of the unlicensed channel, and
controller circuitry configured to control the transmitter circuitry and the receiver circuitry, the controller circuitry being configured with the receiver circuitry
to determine that the transmitter circuitry can transmit data via one or more of the communications resources of the unlicensed channel according to a fixed frame period, including a channel occupancy time for transmitting the data and an idle period, by detecting that none of the infrastructure equipment and the one or more other communications devices are transmitting according to a clear channel assessment, CCA, phase associated with a channel occupancy time of a fixed frame period, and to control the transmitter circuitry to transmit at least part of the data in one or more of the communications resources of the channel occupancy time of the fixed frame period in the unlicensed channel, wherein the controller circuitry is configured
to determine that one or more portions of the channel occupancy time of the fixed frame period are unused by the communications device, the time for transmitting at least part of the data in the channel occupancy time being less than a temporal length of the channel occupancy time, and
to release the one or more portions of the channel occupancy time unused by the communications device as a release device, the one or more portions being released to at least one of the infrastructure equipment and the one or more other communications devices as a recipient device.
   Paragraph 58. Circuitry of a user equipment comprising
transmitter circuitry configured to transmit signals via communications resources of an unlicensed channel of a wireless access interface, the communications resources of the unlicensed channel being shared in time with at least one of an infrastructure equipment of a wireless communications network and one or more other communications devices which can also transmit in the communications resources of the unlicensed channel at different times,
receiver circuitry configured to receive signals transmitted via the communications resources of the unlicensed channel, and
controller circuitry configured to control the transmitter circuitry and the receiver circuitry, the controller circuitry being configured with the receiver circuitry
to determine that the communications device can transmit data via one or more of the communications resources of the unlicensed channel arranged in time according to a fixed frame period, including a channel occupancy time for transmitting the data and an idle period, by detecting that, one of the infrastructure equipment and one of the one or more other communications devices which has transmitted signals on the unlicensed channel in a channel occupancy time of a fixed frame period of the infrastructure equipment or the one other communications device, has released one or more portions of the channel occupancy time of the fixed frame period which are unused by the infrastructure equipment or the one other communications device, the infrastructure equipment or the one other communications device being a release device, and the communications device being a recipient device, and the controller circuitry is configured with the transmitter circuitry
to transmit at least part of the data in one or more of the released portions of the unlicensed channel from the channel occupancy time of the fixed frame period of the release device.
   Paragraph 59. Circuitry for an infrastructure equipment of a wireless communications network for communicating with one or more communications devices, the circuitry comprising
transmitter circuitry configured to transmit signals via communications resources of an unlicensed channel of a wireless access interface, the communications resources of the unlicensed channel being shared in time with one or more other communications devices which can also transmit in the communications resources of the unlicensed channel,
receiver circuitry configured to receive signals transmitted via the communications resources of the unlicensed channel, and
controller circuitry configured to control the transmitter circuitry and the receiver circuitry, the controller circuitry being configured with the receiver circuitry
to determine that the transmitter circuitry can transmit data via one or more of the communications resources of the unlicensed channel arranged in time according to a fixed frame period, including a channel occupancy time for transmitting the data and an idle period, the controller circuitry being configured to determine that the transmitter circuitry can transmit by detecting that one of the one or more other communications devices, which has transmitted signals on the unlicensed channel in a channel occupancy time of a fixed frame period of the other communications device has released one or more portions of the channel occupancy time of the fixed frame period which are unused by the other communications device, the other communications device being a release device, and the infrastructure equipment being a recipient device, and the controller circuitry is configured with the transmitter circuitry
to transmit at least part of the data in one or more of the released portions of the unlicensed channel from the channel occupancy time of the fixed frame period of the release device.
   Paragraph 60. Circuitry for an infrastructure equipment of a wireless communications network for communicating with one or more communications devices, the circuitry comprising
transmitter circuitry configured to transmit signals via communications resources of an unlicensed channel of a wireless access interface, the communications resources of the unlicensed channel being shared in time with one or more other communications devices which can also transmit in the communications resources of the unlicensed channel at different times,
receiver circuitry configured to receive signals transmitted via the communications resources of the unlicensed channel, and
controller circuitry configured to control the transmitter circuitry and the receiver circuitry, the controller circuitry being configured with the receiver circuitry
to determine that the transmitter circuitry can transmit data via one or more of the communications resources of the unlicensed channel according to a fixed frame period, including a channel occupancy time for transmitting the data and an idle period, by detecting that none of the one or more communications devices is transmitting according to a clear channel assessment, CCA, phase associated with a channel occupancy time of a fixed frame period, and,
if none of the communications devices is transmitting in the CCA phase associated with the channel occupancy time of the fixed frame period, to control the transmitter circuitry to transmit at least part of the data in one or more of the communications resources of the channel occupancy time of the fixed frame period in the unlicensed channel, wherein the controller circuitry is configured
to determine that one or more portions of the channel occupancy time of the fixed frame period remain unused by the infrastructure equipment, the time for transmitting at least part of the data in the channel occupancy time being less than a temporal length of the channel occupancy time, and

to release the one or more portions of the channel occupancy time unused by the infrastructure equipment as a release device, the one or more portions being released to the one or more other communications devices as a recipient device.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] TR38.913, “Study on Scenarios and Requirements for Next Generation Access Technologies (Release 14)”, v14.3.0
[2] RP-190726, “Physical layer enhancements for NR ultra-reliable and low latency communication (UR LLC),” Huawei, HiSilicon, RAN #83
[3] RP-191575, “NR-based Access to Unlicensed Spectrum,” Qualcomm, RAN #84
[4] RP-201310, “Revised WID: Enhanced Industrial Internet of Things (IoT) and ultra-reliable and low latency communication (URLLC) support for NR,” Nokia, Nokia Shanghai Bell, RAN #88e
[5] R1-2007391, “Summary #5 on enhancements for unlicensed band URLLC/IIoT for R17,” Moderator (Ericsson), RAN1 #102e
[6] Co-pending European patent application EP20187799.0, “Configured Grant UCI for unlicensed URL LC”
[7] Holma H. and Toskala A, “LTE for UMTS OFDMA and SC-FDMA based radio access”, John Wiley and Sons, 2009.

1. A method of operating a communications device, the method comprising
determining that the communications device can transmit data via one or more communications resources of an unlicensed channel of a wireless access interface, the communications resources of the unlicensed channel being shared in time with at least one of an infrastructure equipment of a wireless communications network and one or more other communications devices which can also transmit in the communications resources of the unlicensed channel, the transmission of the data by the communications device on the unlicensed channel being arranged in time according to a fixed frame period including a channel occupancy time for transmitting the data and an idle period, the determining that the communications device can transmit the data on the communications resources of the unlicensed channel including detecting that none of the infrastructure equipment and the one or more other communications devices are transmitting according to a clear channel assessment, CCA, phase associated with a channel occupancy time of a fixed frame period, and,
transmitting at least part of the data by the communications device in one or more of the communications resources of the channel occupancy time of the fixed frame period in the unlicensed channel, and the method includes
determining that one or more portions of the channel occupancy time of the fixed frame period are unused by the communications device, the time for transmitting at least part of the data in the channel occupancy time being less than a temporal length of the channel occupancy time, and
releasing the one or more portions of the channel occupancy time unused by the communications device as a release device to at least one of the infrastructure equipment and the one or more other communications devices as a recipient device.

2. A method of claim 1, wherein the one or more portions of the channel occupancy time of the fixed frame period unused comprises a remaining portion of the channel occupancy time after the communications device has transmitted at least part of the data, and the method comprises
transmitting, by the communications device, to one of the infrastructure equipment and one of the one or more other communications devices an indication that the infrastructure equipment or the other one of the one or more communications devices can transmit in the remaining portion of the channel occupancy time of the fixed frame period unused by the communications device.

3. A method of claim 1, wherein the releasing the one or more portions of the channel occupancy time unused by the communications device as a release device, comprises transmitting by the communications device as the release device an indication that the communications device is releasing a portion of the channel occupancy time of the fixed frame period that unused by the communications device to the infrastructure equipment or the one of the other communications devices as the recipient device, the communications device transmitting at least part of the data before or after the portion released.

4. A method of claim 3, wherein the portion of the channel occupancy time released is determined dynamically and indicated by transmitting a release signal.

5. A method of claim 3, wherein the portion of the channel occupancy time released is pre-configured using radio resource control signalling before the communications device transmits the data.

6. A method of claim 1, comprising
receiving a force release signal from one of the infrastructure equipment and one of the other communications devices, and the transmitting at least part of the data by the communications device in one or more of the communications resources of the channel occupancy time comprises
transmitting the at least part of the data by the communications device in the one or more communications resources of the channel occupancy time until the force release signal is received, the one or more portions of the channel occupancy time of the fixed frame period remaining unused by the communications device after the force release signal is received, and
transmitting an acknowledgement in response to the force release signal.

7. A method of claim 1, comprising transmitting a release signal indicating the releasing of the one or more portions of the channel occupancy time unused by the communications device as the release device to the recipient device.

8. A method of claim 1, comprising transmitting a release signal indicating that the communications device as the release device is releasing the portion of the channel occupancy time unused by the communications device after the transmission of the release signal.

9. A method of claim 8, wherein the release signal provides an indication of the portion of the channel occupancy time unused by the communications device as an offset from a start of the fixed frame period and a duration of the portion of the remaining one or more communications resources.

10. A method of claim 8, wherein the release signal provides an indication of a pre-configured index of a look-up table each index indicating a different offset from a start of the fixed frame period and a different duration of the portion of the channel occupancy time released by the communications device.

11. A method of claim 7, wherein the release signal identifies one of the infrastructure equipment or one of the one or more other communications devices to which the one or more remaining shared communications resources are being released.

12. A method of claim 7, wherein the recipient device is one of the one or more other communications devices and the release signal is transmitted via a sidelink channel.

13. A method of claim 1, wherein the recipient device is defined as a default for the communications device acting as a release device.

14. A method of operating a communications device to communicate using a wireless communications network, the method comprising
determining that the communications device can transmit data via one or more communications resources of an unlicensed channel of a wireless access interface, the communications resources of the unlicensed channel being shared in time with at least one of an infrastructure equipment of a wireless communications network and one or more other communications devices which can also transmit in the communications resources of the unlicensed channel, the transmission of the data by the communications device on the unlicensed channel being arranged in time according to a fixed frame period including a channel occupancy time for transmitting the data and an idle period, and the determining that the communications device can transmit the data on the communications resources of the unlicensed channel comprises
detecting that one of the infrastructure equipment and one of the one or more other communications devices, which has transmitted signals on the unlicensed channel in a channel occupancy time of a fixed frame period of the infrastructure equipment or the one other communications device has released one or more portions of the channel occupancy time of the fixed frame period which are unused by the infrastructure equipment or the one other communications device, the infrastructure equipment or the one other communications device being a release device, and the communications device being a recipient device, and the method includes
transmitting, by the communications device as the recipient device, at least part of the data in one or more of the released portions of the unlicensed channel from the channel occupancy time of the fixed frame period of the release device.

15. A method of claim 14, wherein the transmitting, by the communications device as the recipient device, at least part of the data in the one or more released portions of the unlicensed channel from the channel occupancy time of the fixed frame period of the release device comprises transmitting at least part of the data by the communications device as the recipient device in the one or more communications resources of the unlicensed channel from a channel occupancy time of a fixed frame period of the communications device as the recipient device.

16. A method of claim 14, wherein the transmitting, by the communications device as the recipient device, at least part of the data in the one or more released portions of the unlicensed channel comprises transmitting at least part of the data by the communications device as the recipient device in the one or more of the released portions according to the channel occupancy time of the fixed frame period of the release device, the fixed frame period of the release device including the channel occupancy time and an idle period.

17. A method of claim 14, wherein the transmitting, by the communications device as the recipient device, at least part of the data in the one or more released portions of the unlicensed channel from the channel occupancy time of the fixed frame period of the release device, comprises transmitting the data by the communications device as the recipient device in the one or more released portions of the unlicensed channel from the channel occupancy time of the fixed frame period of the recipient device as one or more communications resources of a first fixed frame period of the recipient device and one or more communications resources of a channel occupancy time of a second fixed frame period of the recipient device, which second fixed frame period of the recipient device occurs as a next fixed frame period after the first fixed frame period.

18. A method of claim 17, wherein the transmitting the data includes not transmitting the data in an idle period of the first or the second fixed frame period of the recipient device.

19. A method of claim 17, wherein the transmitting the data includes transmitting the data without detecting whether one of the infrastructure equipment or one or more others of the communications devices as the release device transmits signals according to a clear channel assessment, CCA, phase of the unlicensed channel.

20.-52. (canceled)

53. A communications device comprising
transmitter circuitry configured to transmit signals via communications resources of an unlicensed channel of a wireless access interface, the communications resources of the unlicensed channel being shared in time with at least one of an infrastructure equipment of a wireless communications network and one or more other communications devices which can also transmit in the communications resources of the unlicensed channel at different times,
receiver circuitry configured to receive signals transmitted via the communications resources of the unlicensed channel, and
controller circuitry configured to control the transmitter circuitry and the receiver circuitry, the controller circuitry being configured with the receiver circuitry
to determine that the transmitter circuitry can transmit data via one or more of the communications resources of the unlicensed channel according to a fixed frame period, including a channel occupancy time for transmitting the data and an idle period, by detecting that none of the infrastructure equipment and the one or more other communications devices are transmitting according to a clear channel assessment, CCA, phase associated with a channel occupancy time of a fixed frame period, and to control the transmitter circuitry to transmit at least part of the data in one or more of the communications resources of the channel occupancy time of the fixed frame period in the unlicensed channel, wherein the controller circuitry is configured
to determine that one or more portions of the channel occupancy time of the fixed frame period are unused by the communications device, the time for transmitting at least part of the data in the channel occupancy time being less than a temporal length of the channel occupancy time, and
to release the one or more portions of the channel occupancy time unused by the communications device as a release device, the one or more portions being released to at least one of the infrastructure equipment and the one or more other communications devices as a recipient device.

54.-60. (canceled)
